(19) United States
(12) Patent Application Publication
(10) Pub. No.: US 2026/0030481 A1
(43) Pub. Date: Jan. 29, 2026

(54) TEMPORAL AND CONTEXT-BASED TRANSFORMER NEURAL NETWORK FOR IMPROVED COMMUNICATION PROTOCOL SELECTION ACROSS DISPARATE NETWORKS

(71) Applicant: ZS Associates, Inc., Evanston, IL (US)

(72) Inventors: Prakash, Bengaluru (IN); Shishir KUMAR, Pune (IN); Ankush GUPTA, Pune (IN); Omer HANCER, Sharon, MA (US); Kumar RITWIK, Brookline, MA (US); Srinivas Sainaga CHILUKURI, Buffalo Grove, IL (US)

(73) Assignee: ZS Associates, Inc., Evanston, IL (US)

(21) Appl. No.: 19/277,836

(22) Filed: Jul. 23, 2025

(30) Foreign Application Priority Data
Jul. 24, 2024 (IN) 202441056253

(51) Int. Cl. G06N 3/045; G06N 3/084

(52) U.S. Cl. CPC G06N 3/045; G06N 3/084

(57) ABSTRACT

A computer-implemented system can implement a temporal and context-based transformer for improved communication protocol selection across disparate networks. The system can train a transformer-based neural network using embeddings generated separately from, respectively, profile attributes, channel-specific behaviors, external clinical events and/or observed outcomes. The transformer-based neural network can be trained to reconstruct masked events and inter-event time gaps, then fine-tuned with a dual-loss objective that simultaneously preserves behavioral grammar and maximizes outcome prediction accuracy. During live operation the model ingests current profile, real-time telemetry and new contextual events to temporally and contextually select communication channels to generate events across disparate networks.

### CROSS-REFERENCE TO RELATED APPLICATIONS

This application claims priority to Indian Provisional Application No. 202441056253, filed Jul. 24, 2025, which is incorporated herein by reference in its entirety for all purposes.

### TECHNICAL FIELD

The present disclosure relates to implementing a temporal and context-based transformer neural network for improved communication protocol selection across disparate networks. The method involves using an enhanced machine learning model to automatically perform electronic communication across multiple electronic channels of disparate networks by integrating data from diverse data sources.

### BACKGROUND

Optimizing electronic communication protocols across multiple network channels, such as CRM software interactions, emails, and third-party vendor activities, has become more ubiquitous with the recent advances in Internet/electronic communication networking channels. Traditional methods have evolved to incorporate machine learning and deep learning algorithms like convolutional neural networks (CNNs). However, these conventional models face significant challenges in scalability and in capturing the complex temporal and contextual relationships within the data. CNNs struggle with the “curse of dimensionality” and sparsity when handling the diverse and large datasets characteristic of communication protocols. Furthermore, existing models are often unable to effectively integrate real-world evidence and contextual information, leading to suboptimal communication protocol selection and integration.

### SUMMARY

Enhancing customer experience through personalized electronic communication protocol selection has always been a priority. Achieving this requires a deep understanding of “moments that matter,” which extend beyond brand engagement to encompass events like patient progression and industry participation. While such data richness offers valuable insights into customer behavior, mining this multi-dimensional sequential data poses significant challenges.

The systems and methods described herein overcome these technical challenges using customized machine learning architecture, which may be tailored to preserve order and temporal information. The models discussed herein incorporate context-based, temporal, and event-specific embeddings, along with adaptive loss functions, to improve feature representation and model performance. The architecture discussed herein facilitates the integration of pharmaceutical and non-pharmaceutical events, effectively addressing issues of class imbalance, rare events, noisy data, and low event volume/velocity. Through supervised deep learning networks, the models discussed herein (e.g., EX-BERT) predict customer prescription behavior, offering a comprehensive solution to the complexities of high-dimensional sequential data analysis in the pharmaceutical domain.

The methods and systems discussed herein provide an enhanced machine learning model (sometimes referred to herein as the expert BERT or EX-BERT), customized for pharmaceutical omnichannel orchestration and selection and automated communication, incorporating temporal embeddings, domain-specific contextual embeddings, and an optimization framework to provide a scalable, efficient, and highly accurate solution for optimizing electronic communication across disparate networks (e.g., communications networks, such as networks involving communication through different ports and/or antennas of a computing device).

Conventional models suffer from various technical challenges. The methods and systems discussed herein solve many of these technical challenges. For instance, the methods and systems discussed herein are tailored toward solving the inefficiency and limitations of existing and conventional computer models, particularly convolutional neural networks (CNNs), in handling the complex, multi-dimensional, and temporal nature of pharmaceutical data.

Scalability Issues with conventional CNNs: Conventional CNNs face technical challenges in scaling when dealing with the increasing dimensions of data in pharmaceutical-specific communication. As more data dimensions are added, the CNN's matrix becomes sparse, leading to computational inefficiencies and difficulty in training the model effectively.

Capturing Temporal Dependencies: Existing models, such as CNNs, are not well-suited to capture the temporal relationships between events in a pharmaceutical communication sequence. For instance, the impact of an email followed by a call can differ significantly based on the time interval between these events. Conventional models lack the ability to incorporate these temporal dynamics accurately.

Incorporating Contextual and Domain-Specific Information: There is a need for a model that can incorporate domain-specific contextual information, such as patient claims data, managed care data, and other real-world evidence, into the communication strategy. Existing models do not effectively integrate this type of information, limiting their predictive accuracy and effectiveness in optimizing communication activities.

Holistic View of Customer Journey: Pharmaceutical companies require a comprehensive view of the customer journey across multiple communication channels, including CRM interactions, emails, third-party vendor activities, and the like. Existing solutions do not adequately integrate data from diverse sources to provide this holistic view, resulting in suboptimal communication strategies.

Optimization of Communication Touchpoints: There is a need for an optimization framework that can iteratively adjust communication touchpoints (such as the timing, channel, and content of interactions) to maximize desired outcomes, like total prescription value (Trx). Current models do not effectively address the constraints and operational considerations inherent in pharmaceutical communication, limiting their ability to design personalized and effective communication strategies.

The present disclosures addresses these problems by introducing an enhanced version of the machine learning model, customized for pharmaceutical omnichannel orchestration. This model incorporates temporal embeddings, domain-specific contextual embeddings, and an optimization framework to provide a scalable, efficient, and highly accurate solution for orchestrating communication activities across multiple channels.

To address the technical challenges of conventional models, the present disclosure introduces a novel approach that leverages an enhanced version of bidirectional encoders and transformers, such as Bidirectional Encoders Representations from Transformers (BERT), customized and modified for pharmaceutical omnichannel orchestration purposes and to improve its performance. This expert model, referred to sometimes as “expert” or simply the “model,” incorporates several modifications to the standard transformer architecture, including the introduction of temporal embeddings and domain-specific contextual embeddings. These enhancements enable the model to effectively capture the temporal dynamics and contextual nuances of pharmaceutical events.

The expert model is designed to optimize the customer journey across various communication channels, including CRM calls, emails, and third-party vendor interactions. By integrating data from multiple sources, such as sales transactions, customer demographics, and real-world evidence (e.g., patient claims and managed care data), the expert model provides a comprehensive view of the customer's journey. This holistic approach allows for more accurate predictions of outcomes and facilitates the design of highly personalized communication strategies. Furthermore, the methods and systems discussed herein include an optimization framework that iteratively adjusts touchpoints to maximize the desired outcomes, such as total prescription value (Trx). This framework addresses the constraints and operational considerations inherent in pharmaceutical communication, ensuring that the pharmaceutical activities are both effective and compliant with regulatory requirements.

Accordingly, the present disclosure represents a technical advancement in the field of machine learning identification of field-specific communication by providing a scalable, efficient, and highly accurate expert model for orchestrating communication across multiple selected electronic channels. The expert model's ability to incorporate temporal and contextual information sets it apart from existing solutions, offering pharmaceutical companies an enhanced paradigm to enhance and automate their electronic communication.

In some aspects, the techniques described herein relate to a method for optimizing and directing electronic communication using transformer-based neural networks, the method including: generating, by one or more processors, from a set of electronic data sources, a training dataset including user profile data, time-stamped behavioral records captured across a plurality of electronic communication channels, external contextual events, and outcome indicators associated with clinical results; training, by one or more processors, a transformer-based neural network with the training dataset by: pre-training the transformer-based neural network to learn temporal relationships among events and actions, and fine-tuning the pre-trained transformer-based neural network so as to reduce divergence between predicted outcomes and the outcome indicators by optimizing a dual-loss function that (i) applies a generative reconstruction loss causing the transformer-based neural network to predict masked events, and (ii) applies a discriminative outcome loss causing the transformer-based neural network to predict the recorded outcome indicators; executing, by the one or more processors, the trained transformer-based neural network using a current user profile data, recent behavioral signals, and contemporaneous external events; and outputting, by the one or more processors, an electronic communication instruction associated with the current user profile generated via the trained transformer-based neural network.

In some aspects, the techniques described herein relate to a method, further including: retrieving, by the one or more processors, the pretrained network.

In some aspects, the techniques described herein relate to a method, wherein the two losses being combined as a weighted sum whose gradients are jointly back-propagated through shared network parameters.

In some aspects, the techniques described herein relate to a method, wherein the transformer-based neural network is an enhanced Bidirectional Encoder Representations from Transformers.

In some aspects, the techniques described herein relate to a method, wherein the transformer-based neural network is trained to increase a total value (Trx).

In some aspects, the techniques described herein relate to a method, further including: automatically executing, by the one or more processors, the electronic communication instruction.

In some aspects, the techniques described herein relate to a method, wherein the electronic communication instruction is causing an electronic communication session to be established between a device of a user and a secondary device.

In some aspects, the techniques described herein relate to a method, wherein the electronic communication instruction is causing an electronic communication session to be established between a device of a user and a secondary device.

In some aspects, the techniques described herein relate to a system for optimizing and directing electronic communication using transformer-based neural networks, the system including a computer-readable medium having a set of non-transitory instructions that when executed by one or more processors, cause the oner or more processors to: generate from a set of electronic data sources, a training dataset including user profile data, time-stamped behavioral records captured across a plurality of electronic communication channels, external contextual events, and outcome indicators associated with clinical results; train a transformer-based neural network with the training dataset by: pre-training the transformer-based neural network to learn temporal relationships among events and actions, and fine-tuning the pre-trained transformer-based neural network so as to reduce divergence between predicted outcomes and the outcome indicators by optimizing a dual-loss function that (i) applies a generative reconstruction loss causing the transformer-based neural network to predict masked events, and (ii) applies a discriminative outcome loss causing the transformer-based neural network to predict the recorded outcome indicators; execute the trained transformer-based neural network using a current user profile data, recent behavioral signals, and contemporaneous external events; and output an electronic communication instruction associated with the current user profile generated via the trained transformer-based neural network.

In some aspects, the techniques described herein relate to a system, wherein the instruction further cause the one or more processors to retrieve the pre-training the transformer-based neural network.

In some aspects, the techniques described herein relate to a system, wherein the two losses being combined as a weighted sum whose gradients are jointly back-propagated through shared network parameters.

In some aspects, the techniques described herein relate to a system, wherein the transformer-based neural network is an enhanced Bidirectional Encoder Representations from Transformers.

In some aspects, the techniques described herein relate to a system, wherein the transformer-based neural network is trained to increase a total value (Trx).

In some aspects, the techniques described herein relate to a system, wherein the instruction further cause the one or more processors to automatically execute the electronic communication instruction.

In some aspects, the techniques described herein relate to a system, wherein the electronic communication instruction is causing an electronic communication session to be established between a device of a user and a secondary device.

In some aspects, the techniques described herein relate to a system, wherein the electronic communication instruction is causing an electronic communication session to be established between a device of a user and a secondary device.

In some aspects, the techniques described herein relate to a system for optimizing and directing electronic communication using transformer-based neural networks, the system including one or more processors configured to: generate from a set of electronic data sources, a training dataset including user profile data, time-stamped behavioral records captured across a plurality of electronic communication channels, external contextual events, and outcome indicators associated with clinical results; train a transformer-based neural network with the training dataset by: pre-training the transformer-based neural network to learn temporal relationships among events and actions, and fine-tuning the pre-trained transformer-based neural network so as to reduce divergence between predicted outcomes and the outcome indicators by optimizing a dual-loss function that (i) applies a generative reconstruction loss causing the transformer-based neural network to predict masked events, and (ii) applies a discriminative outcome loss causing the transformer-based neural network to predict the recorded outcome indicators; execute the trained transformer-based neural network using a current user profile data, recent behavioral signals, and contemporaneous external events; and output an electronic communication instruction associated with the current user profile generated via the trained transformer-based neural network.

In some aspects, the techniques described herein relate to a system, wherein the one or more processors are further configured to retrieve the pretrained network instead of pre-training the network.

In some aspects, the techniques described herein relate to a system, wherein the two losses being combined as a weighted sum whose gradients are jointly back-propagated through shared network parameters.

In some aspects, the techniques described herein relate to a system, wherein the transformer-based neural network is an enhanced Bidirectional Encoder Representations from Transformers.

### BRIEF DESCRIPTION OF THE DRAWINGS

FIG. 1A is a block diagram of embodiments of a computing device, in accordance with one or more embodiments.

FIG. 1B is a block diagram depicting a computing environment comprising client devices in communication with cloud service providers, in accordance with one or more embodiments.

FIG. 2 is a block diagram of an example system in which communication prediction management services may manage and streamline access by clients to resource feeds (via one or more gateway services) and/or software-as-a-service (SaaS) applications, in accordance with one or more embodiments.

FIGS. 3A-B are examples of computing environment for the AI-backed communication prediction system, in accordance with one or more implementations.

FIG. 4 is an example of a flowchart of a method implemented in an AI-backed communication prediction system, in accordance with one or more embodiments.

FIG. 5 is an example of a flowchart of a method implemented in an AI-backed communication prediction system, in accordance with one or more embodiments.

FIGS. 6A-10 are examples of implementations of an AI-backed communication prediction system.

FIG. 11 is an example of a flowchart of a method implemented in an AI-backed communication prediction system, in accordance with one or more embodiments.

FIG. 12 is an example of implementations of an AI-backed communication prediction system.

### DETAILED DESCRIPTION

Non-limiting examples of various aspects and variations of the embodiments are described herein and illustrated in the accompanying drawings.

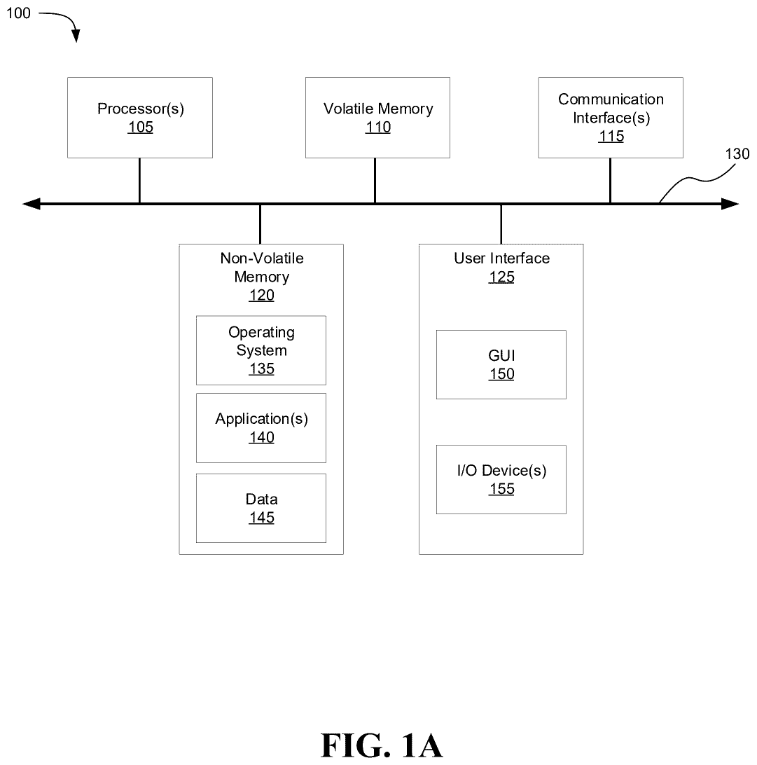

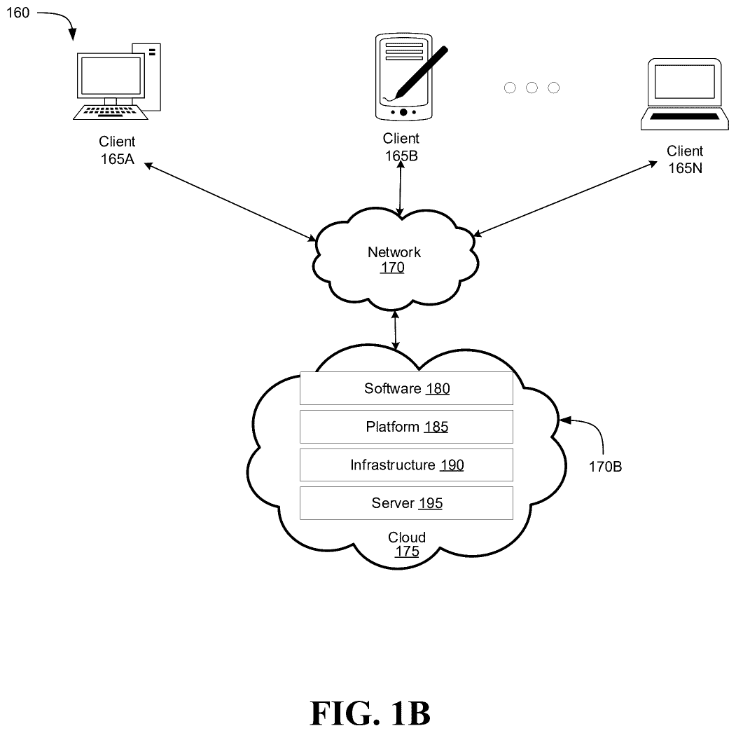

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid-state drives (SSDs) such as a flash drive or other solid-state storage media, one or more hybrid magnetic and solid-state drives, and/or one or more virtual storage volumes, such as cloud storage, or a combination of such physical storage volumes and virtual storage volumes or arrays thereof), user interface (UI) 125, one or more communications interfaces 115, and communication bus 130. User interface 125 may include a graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). The non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than the main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary, and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hardcoded into the circuitry or soft coded by way of instructions held in a memory device and executed by the circuitry.

A “processor” may perform the function, operation, or sequence of operations using digital values and/or using analog signals. In some embodiments, the “processor” can be embodied in one or more application-specific integrated circuits (ASICs), microprocessors, digital signal processors (DSPs), graphics processing units (GPUs), microcontrollers, field-programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors may provide functionality for parallel, simultaneous execution of instructions, or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of one or more applications, one or more desktop applications, and one or more desktop sessions in which one or more applications may execute.

Referring to FIG. 1B, a computing environment 160 is depicted. Computing environment 160 may generally be implemented as a cloud computing environment, an on-premises (“on-prem”) computing environment, or a hybrid computing environment including one or more on-prem computing environments and one or more cloud computing environments. When implemented as a cloud computing environment, also referred to as a cloud environment, cloud computing, or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include but are not limited to, networks, network bandwidth, servers, processing, memory, storage, applications, virtual machines, databases, software, hardware, analytics, and intelligence.

In some embodiments, the computing environment 160 may provide client 165 with one or more resources provided by a network environment. The computing environment 160 may include one or more clients 165a-165n, in communication with a cloud 175 over one or more networks 170. Clients 165 may include, e.g., thick clients, thin clients, and zero clients. The cloud 108 may include back-end platforms, e.g., servers, storage, server farms, or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In some embodiments, the computing environment 160 can include a hybrid cloud that is a combination of a public cloud and a private cloud. For example, the cloud 175 may be public, private, or hybrid. Public clouds 108 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back-end platforms, e.g., servers, storage, server farms, or data centers. For example, the cloud 175 can include or correspond to a server or system remote from one or more clients 165 to provide third-party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of the software, an application, or a software application to serve multiple users. In some embodiments, the computing environment 160 can provide on-demand self-service to unilaterally provision computing capabilities (e.g., server time, network storage) across a network for multiple clients 165. The computing environment 160 can provide elasticity to dynamically scale out or scale in responsive to different demands from one or more clients 165. In some embodiments, the computing environment 160 can include or provide monitoring services to monitor, control, and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud-based delivery, e.g., Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers, or virtualization resources from large pools, allowing the users to quickly scale up by accessing more resources as needed. Examples of IaaS include AMAZON WEB SERVICES provided by Amazon.com, Inc., of Seattle, Washington; RACKSPACE CLOUD provided by Rackspace US, Inc., of San Antonio, Texas; Google Compute Engine provided by Google Inc. of Mountain View, California; or RIGHTSCALE provided by RightScale, Inc., of Santa Barbara, California. PaaS providers may offer functionality provided by IaaS, including, e.g., storage, networking, servers, or virtualization, as well as additional resources such as, e.g., the operating system, middleware, or runtime resources. Examples of PaaS include WINDOWS AZURE provided by Microsoft Corporation of Redmond, Washington; Google App Engine provided by Google Inc.; and HEROKU provided by Heroku, Inc., of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc.; SALESFORCE provided by Salesforce.com Inc. of San Francisco, California; or OFFICE 365 provided by Microsoft Corporation. Examples of SaaS may also include data storage providers, e.g., DROPBOX provided by Dropbox, Inc., of San Francisco, California; Microsoft SKYDRIVE provided by Microsoft Corporation; Google Drive provided by Google Inc.; or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as e.g., Advanced Encryption Standard (AES). Data resources may be sent over Transport Layer Security (TLS) or Secure Sockets Layer (SSL).

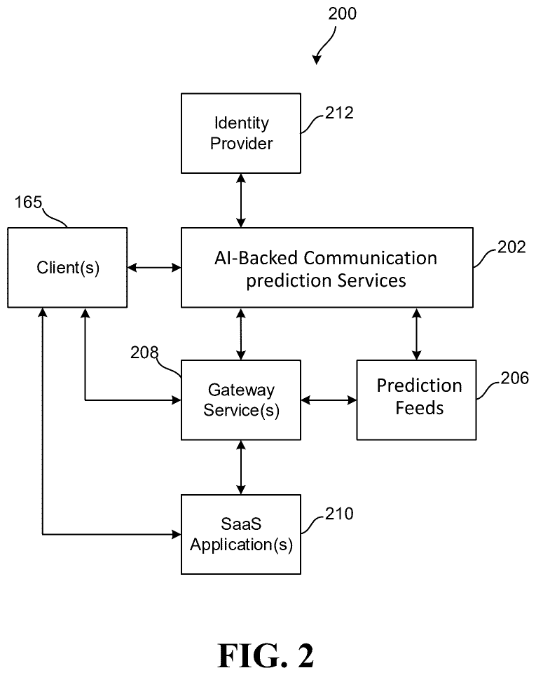

FIG. 2 is a block diagram of an example system 200 in which an AI-backed communication prediction services server 202 may manage and streamline access by one or more clients 165 to one or more prediction feeds 206 (via one or more gateway services 208) and/or one or more software-as-a-service (SaaS) applications 210. As used herein, a prediction feed is a result of the execution of one or more AI models discussed herein. In particular, the AI-backed communication prediction services server 202 may employ an identity provider 212 to authenticate the identity of a user of a client 165 and, following authentication, identify one or more prediction feeds the user is authorized to access. For the prediction feed(s) 206, the client 165 may input attributes associated with a product and may request access to one or more AI models via a gateway service 208. For the SaaS application(s) 210, the client 165 may access the selected application directly. The SaaS application(s) 210 may allow the client 165 to access the platform discussed herein and view the prediction feeds 206.

The client(s) 165 may be any type of computing device capable of accessing the prediction feed(s) 206 and/or the SaaS application(s) 210, and may, for example, include a variety of desktop or laptop computers, smartphones, tablets, etc. Each of the AI-backed communication prediction services server 202, the prediction feed(s) 206, the gateway service(s) 208, the SaaS application(s) 210, and the identity provider 212 may be located within an on-premises data center of an organization for which the system 200 is deployed, within one or more cloud computing environments, or elsewhere.

As will be described throughout, a server of an AI-backed communication prediction system 300 (such as an analytics server 310a) can retrieve and analyze data using various methods described herein to predict one or more attributes of a communication (e.g., communication with a pharmaceutical representative).

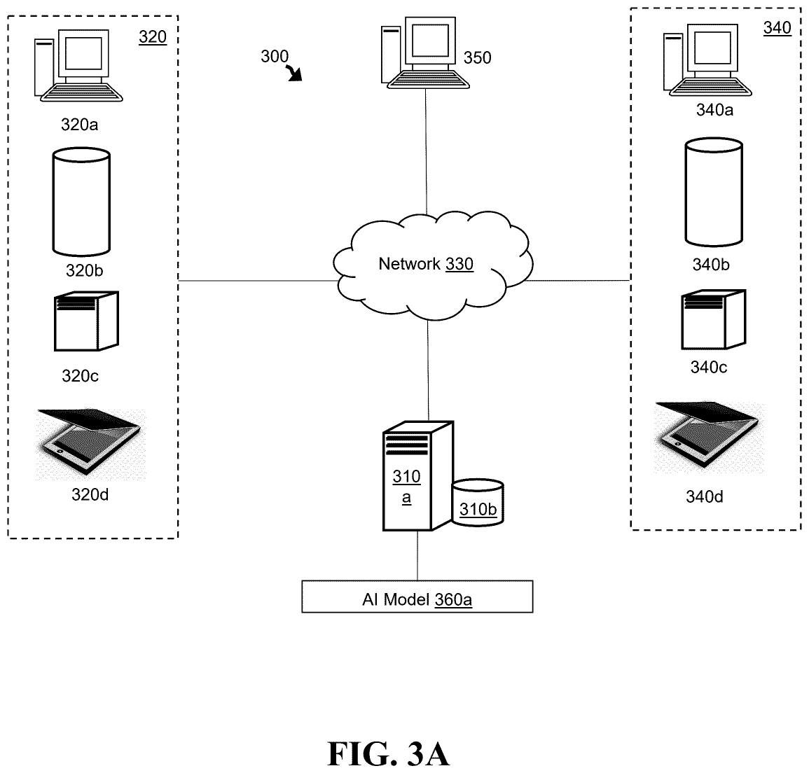

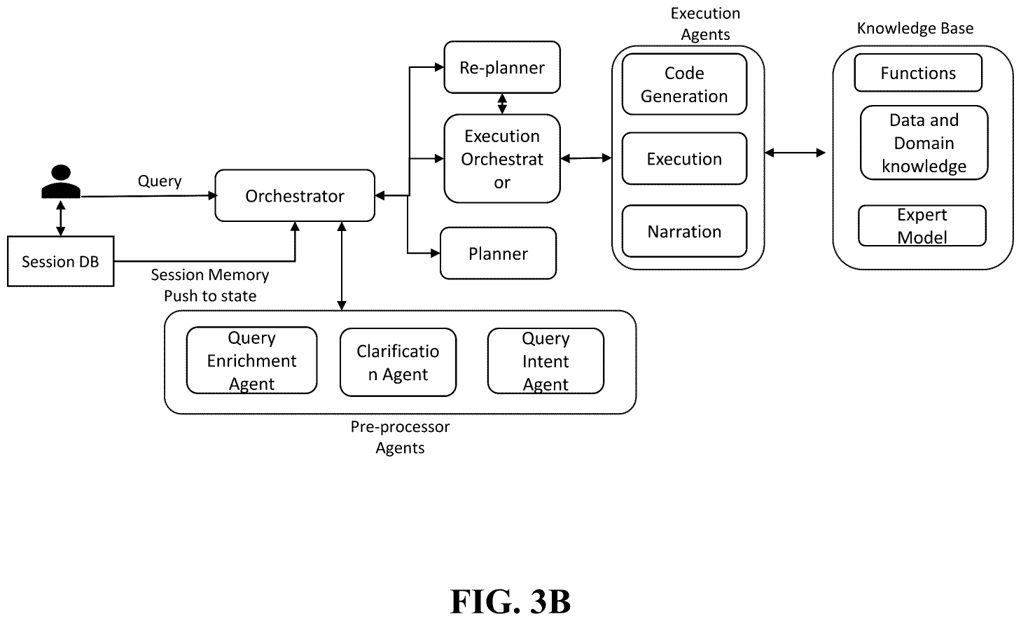

FIG. 3A is a non-limiting example of components of the AI-backed performance prediction system 300 in which the analytics server 310a operates. The analytics server may be any computer, server, or processor described in FIGS. 1A-2.

The analytics server 310a may utilize features described in FIG. 3A to retrieve data and to generate/display results. The analytics server 310a is communicatively coupled to a system database 310b, electronic data sources 320a-d (collectively electronic data sources 320), end-user devices 340a-d (collectively end-user device 340), and an administrator computing device 350. The system 300 is not confined to the components described herein and may include additional or alternative components, not shown for brevity, which is to be considered within the scope of the embodiments described herein.

The above-mentioned components may be connected through a network 330. The examples of the network 330 may include but are not limited to, private or public LAN, WLAN, MAN, WAN, and the Internet. The network 330 may include both wired and wireless communications according to one or more standards and/or via one or more transport mediums.

The analytics server 310a may utilize one or more application programming interfaces (APIs) to communicate with one or more of the electronic devices described herein. For instance, the analytics server may utilize APIs to automatically receive data from the electronic data sources 320. The analytics server 310a can receive data as it is generated, monitored, and/or processed by the electronic data source 320. For instance, the analytics server 110a may utilize an API to receive performance data from the database 320b (e.g., third party rating agency) without any human intervention. This automatic communication allows for faster retrieval and processing of data.

The analytics server 310a may generate and/or host an electronic platform having a series of graphical user interfaces (GUIs) configured to use various computer models (including artificial intelligence (AI) models) to project and display performance metrics. The platform can be displayed on the electronic data sources 320, the administrator computing device 350, and/or end-user devices 340. An example of the platform generated and/or hosted by the analytics server 310a may be a web-based application or a website configured to be displayed on different electronic devices, such as mobile devices, tablets, personal computers, and the like. Even though certain embodiments discuss the analytics server 310a displaying the results, it is expressly understood that the analytics server 310a may either directly generate and display the platform described herein or may present the data to be presented on a GUI displayed on the end-user devices 340.

The analytics server 310a may host a website (also referred to herein as the platform) accessible to end-users operating any of the electronic devices described herein (e.g., end-users), where the content presented via the various webpages may be controlled based upon each particular user's role or viewing permissions. The analytics server 310a may be any computing device comprising a processor and non-transitory machine-readable storage capable of executing the various tasks and processes described herein. Non-limiting examples of such computing devices may include servers, computers, workstation computers, personal computers, and the like. While this example of the system 300 includes a single analytics server 310a, in some configurations, the analytics server 310a may include any number of computing devices operating in a distributed computing environment.

The analytics server 310a may execute one or more software applications configured to display the platform (e.g., host a website), which may generate and serve various webpages to each electronic data sources 320 and/or end-user devices 340. Different end-users may use the website to view and/or interact with the predicted results.

The analytics server 310a may be configured to require user authentication based upon a set of user authorization credentials (e.g., username, password, biometrics, cryptographic certificate, and the like). In such implementations, the analytics server 310a may access the system database 310b configured to store user credentials, which the analytics server 310a may be configured to reference to determine whether a set of entered credentials (purportedly authenticating the user) match an appropriate set of credentials that identify and authenticate the user.

The analytics server 310a may also store data associated with each user operating one or more electronic data sources 320 and/or end-user devices 340. The analytics server 310a may use the data to determine whether a user device is authorized to view results generated by the AI models.

The analytics server 310a may receive product data, market data, or any other pertinent data from one or more of the electronic data sources 320. The electronic data sources 320 may represent different databases or third-party vendors who possess historical product data, performance data, and the like. For instance, the electronic data sources 320 may represent computers, databases, and servers of a CRM vendor (or chain of grocery stores). In another example, the electronic data sources 320 may represent a rating agency providing consumer sentiment data regarding a particular product or feedback received from other pharmaceutical representatives. The analytics server 310a may use the data collected from the electronic data sources 320 to train the AI model 360a. Specifically, the analytics server 310a may retrieve data from the electronic data sources 320 and process the collected data, thereby generating a training dataset. The analytics server may then train the AI model 360a using the training dataset. The analytics server 310a then displays the results via the platform (e.g., GUIs described herein) on the administrator computing device 350 or the end-user devices 340.

The end-user devices 340 may be any computing device comprising a processor and a non-transitory machine-readable storage medium capable of performing the various tasks and processes described herein. Non-limiting examples of an end-user device may include workstation computers, laptop computers, tablet computers, and server computers. In operation, various end-users may use end-user devices 340 to access the platform operationally managed by the analytics server 310a to enter product information and view predicted/projected results.

The administrator computing device 350 may represent a computing device operated by a system administrator. The administrator computing device 350 may be configured to display retrieved data, in the form of results generated by the analytics server 110a, where the system administrator can monitor various models utilized by the analytics server 110a, review feedback, and modify various thresholds/rules described herein. In a non-limiting example, the system administrator may monitor the training of the AI models and/or generation of the training datasets.

The analytics server 310a may access, train, and execute a plurality of AI models. Although the example system 300 depicts the AI models stored on the analytics server 310a, the AI models may be stored on another device or server (e.g., store locally or in cloud storage).

FIG. 3B schematically illustrates an explainability architecture that operates in conjunction with the recommendation engine to convert opaque model artefacts into stakeholder-ready insights. At the top of the diagram a “Model Output Collector” receives, for every inference request, the raw tensors emitted by the trained transformer, including self-attention matrices, hidden-state vectors, and predicted-probability scores. These tensors flow into a middle-tier module labelled “Feature Attribution & Transformation,” where one or more processors apply token-level attribution techniques, such as attention roll-up, integrated gradients, or SHAP value decomposition, to quantify the marginal contribution that each event in the customer journey makes to the model's final recommendation. The resulting importance scores are normalized, time-aligned, and paired with their corresponding semantic labels (channel, content type, market event, patient event, and the like).

The transformed explanations are next routed to a “Context Aggregator” that performs two complementary functions. First, it generates case-specific narratives by selecting the top-ranked drivers for an individual recommendation and formatting them as plain-language rationales (for example, “Webinar attendance and recent patient switch together increased the probability of dosing-calculator e-mail selection by 27%”). Second, it computes population-level statistics—means, medians, and confidence intervals—for each token class across thousands of inferences, thereby revealing systemic patterns that can inform compliance reviews and channel-capacity planning.

Both the individual rationales and the aggregate summaries are persisted in an “Explainability Store,” shown on the right-hand side of the figure as a vertically oriented repository. Downstream applications, field-force dashboards, medical-affairs portals, and audit-trail extractors, access this store through a version-controlled application-programming interface. Because every explanation record carries a cryptographic hash of the model version and input sequence, external regulators and internal quality teams can reproduce the reasoning path that led to any specific communication instruction. In this manner the architecture depicted in FIG. 3B ensures that every next-best-action recommendation is accompanied by transparent, auditable evidence, thereby satisfying both operational and regulatory requirements without compromising model performance.

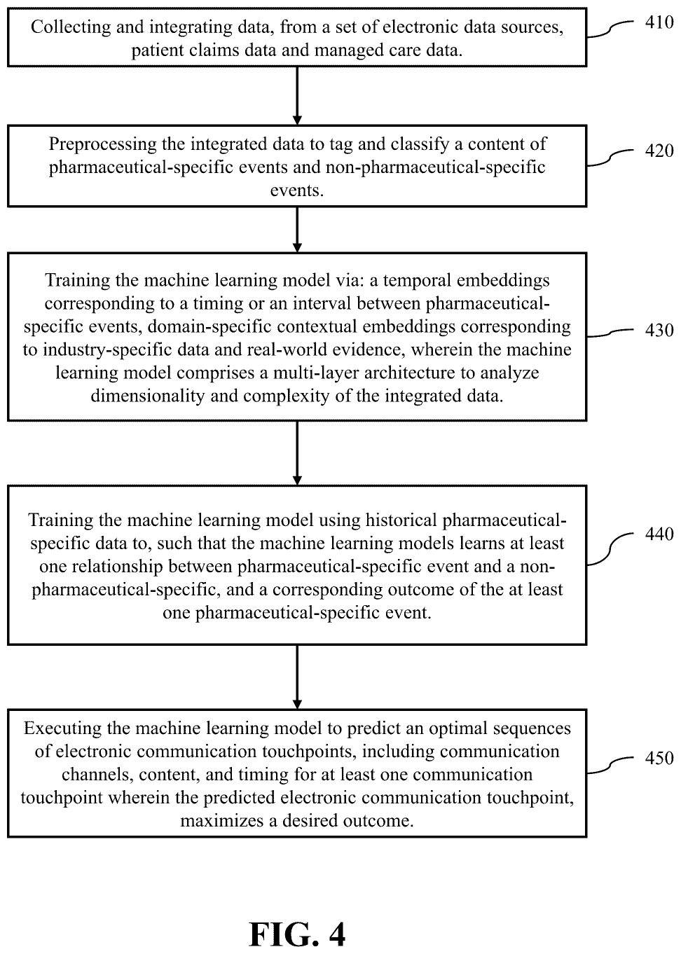

FIG. 4 is a flowchart of an example method for a method for improving omnichannel electronic communication selection across disparate networks using a machine learning model, the method comprising. The method 400 includes steps 410-450. However, other embodiments may include additional or alternative execution steps or may omit one or more steps altogether. In addition, the method 400 is described as being executed by a system, similar to the AI-backed communication prediction system described in FIG. 3A. Different steps of the method 400 or different parts of the different steps may be executed by any number of computing devices operating in the distributed computing system described in FIGS. 1A-3. Furthermore, even though some aspects of the method 400 are described in the context of predicting the performance of a food product, the methods and systems described herein apply to analyzing any product or product concept and are not limited to food products.

At step 410, the analytics server may collect and integrate data from a set of electronic data sources, patient claims data and managed care data. In this step, data from multiple electronic sources may be collected and integrated into a unified dataset. This data may include sales activity, customer demographics, patient claims, and managed care information. The integration process may involve aggregating this diverse data into a comprehensive format that can be efficiently processed by the machine learning model. This may provide that all relevant information may be available for analysis, providing a complete picture of the customer journey and interactions.

At step 420, the analytics server may preprocess the integrated data to tag and classify a content of pharmaceutical-specific events and non-pharmaceutical-specific events. In some embodiments, the integrated data is then preprocessed to prepare it for training the machine learning model. Preprocessing may involve cleaning the data to remove noise and inconsistencies, tagging the data to identify and classify pharmaceutical-specific events (e.g., emails and calls to the doctors) and non-pharmaceutical-specific events (e.g., patient switches, managed care changes). This step may ensure that the data is structured and labeled correctly, enabling the model to learn effectively from the diverse set of inputs.

At step 430, the analytics server may train the machine learning model via: a temporal embeddings corresponding to a timing or an interval between pharmaceutical-specific events, domain-specific contextual embeddings corresponding to industry-specific data and real-world evidence, wherein the machine learning model comprises a multi-layer architecture to analyze dimensionality and complexity of the integrated data. The model may be enhanced with temporal embeddings that capture the timing and intervals between events. Temporal embeddings may help the model understand how the timing of interactions, such as the interval between an email and a follow-up call, affects their overall impact. In this way, the analytics server may ensure that the model to learn the temporal dynamics of pharmaceutical-specific events and their influence on outcomes.

In some embodiments, domain-specific contextual embeddings are incorporated to include industry-specific data and real-world evidence, such as patient claims data and managed care events. These embeddings provide contextual knowledge that enhances the model's ability to predict outcomes based on industry-specific factors. By integrating this contextual information, the model can make more accurate predictions and optimize communication strategies effectively. The machine learning model, particularly an enhanced transformer model (e.g., BERT), may be designed with a multi-layer architecture to handle the high dimensionality and complexity of the integrated dataset. This architecture may allow the model to process large volumes of data with multiple features, ensuring computational efficiency and maintaining accuracy in predictions and optimizations.

At step 440, the analytics server may train the machine learning model using historical pharmaceutical-specific data to, such that the machine learning models learns at least one relationship between pharmaceutical-specific event and a non-pharmaceutical-specific, and a corresponding outcome of the at least one pharmaceutical-specific event. The model may be trained using historical data to learn the relationships between pharmaceutical-specific events, non-pharmaceutical-specific events, and their corresponding outcomes. In some embodiments, during this training phase, the model analyzes patterns and correlations in the historical data, identifying how different types of interactions and events impact desired outcomes, such as total prescription value (Trx). In some embodiments, this training process enables the model to develop a deep understanding of the factors that drive successful communication strategies.

At step 450, the analytics server may execute the model to predict an optimal sequences of electronic communication touchpoints, including communication channels, content, and timing for at least one communication touchpoint wherein the predicted electronic communication touchpoint, maximizes a desired outcome. In some embodiments, once trained, the model executes predictions to determine the optimal sequences of electronic communication touchpoints. These touchpoints include various communication channels (e.g., email, phone calls), the specific content of the communications (e.g., safety information, dosing instructions), and the timing of these interactions. The model uses its learned understanding of the relationships between events and outcomes to recommend sequences that maximize the desired outcome, such as total prescription value.

In some embodiments, the predicted optimal sequences are then deployed in a real-world environment. This step may involve implementing the recommended communication strategies, ensuring that the healthcare providers receive the most relevant and timely interactions. By deploying these optimized sequences, pharmaceutical companies can enhance their impact and achieve better engagement with healthcare providers.

In some embodiments, after deployment, the performance of the optimized communication sequences is continuously monitored. Key performance indicators (KPIs) such as engagement rates, prescription values, and customer feedback are tracked to assess the effectiveness of the deployed strategies. If any significant changes or drifts in performance are observed, the machine learning model is retrained using new data to adapt to evolving patterns and maintain its accuracy. This continuous improvement cycle ensures that the model remains effective in optimizing pharmaceutical communication strategies over time.

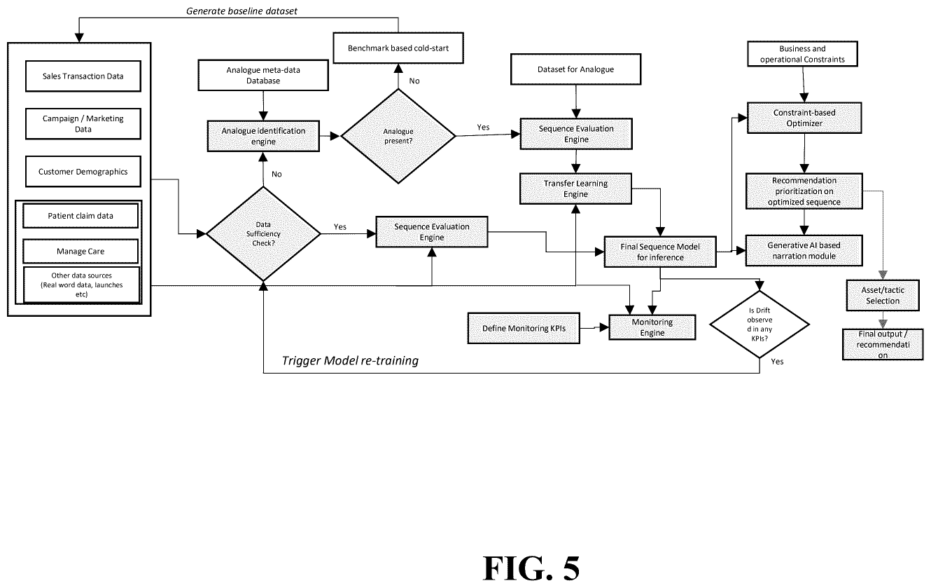

Referring now to FIG. 5, the drawing presents a high-level flow diagram of the complete omnichannel-optimization pipeline implemented by the disclosed methods/systems. The illustrated sequence begins with multi-source data ingestion and preprocessing, proceeds through the expert model inference and dual-loss training stages, and terminates with schedule deployment and closed-loop performance monitoring. Arrows in the diagram further highlight the iterative feedback paths that enable the model to retrain itself automatically as new pharmaceutical and non-pharmaceutical events accumulate in the production environment.

The depicted flowchart provides a comprehensive visual representation of the method for optimizing pharmaceutical omnichannel electronic communication using an enhanced transformer model, such as BERT. It begins with the steps of data collection and integration, where diverse data sources, including sales transactions, customer demographics, patient claims, and managed care data, are aggregated into a unified dataset. This step ensures that all relevant information is available for analysis, providing a holistic view of the customer's journey and interactions. The integration of such diverse data is foundational for the subsequent steps, ensuring that the machine learning model has access to a rich and comprehensive dataset.

Following data integration, the flowchart depicts the preprocessing steps. Here, the integrated data undergoes cleaning to remove any inconsistencies or noise, ensuring high data quality. The data is then tagged and classified to identify and categorize pharmaceutical-specific events (e.g., emails and/or call to the healthcare provider) and non-pharmaceutical-specific events (e.g., patient switches, managed care changes). This structured data is used for training the machine learning model effectively. The preprocessing stage sets the stage for model enhancement, where the generic transformer model is customized and enhanced with temporal embeddings to capture the timing and intervals between events, and domain-specific contextual embeddings to integrate industry-specific data and real-world evidence. The multi-layer architecture of the model is designed to handle the high dimensionality and complexity of the integrated data, ensuring efficient processing and accurate predictions.

The flowchart further depicts the model's operational phases, including training, prediction, optimization, deployment, and continuous monitoring. During training, the expert model learns relationships between different events and their outcomes using historical data. The trained model predicts optimal sequences of electronic communication touchpoints, specifying the best channels, content, and timing for each interaction to maximize desired outcomes such as total prescription value. The optimization framework iteratively refines these sequences, considering regulatory compliance and operational constraints. Once optimized, the sequences are deployed in a real-world environment, orchestrating the customer journey across multiple electronic channels. Continuous performance monitoring ensures the model remains effective, with provisions for retraining to adapt to new data and maintain accuracy, ensuring the system evolves with changing dynamics in the pharmaceutical industry.

Identifying the right communication channel and right content at the right time for every customer has always been a primary goal of the pharmaceutical industry, to improve customer's experience. Devising a personalized omnichannel next best action strategy requires a good understanding of “moments that matter.”

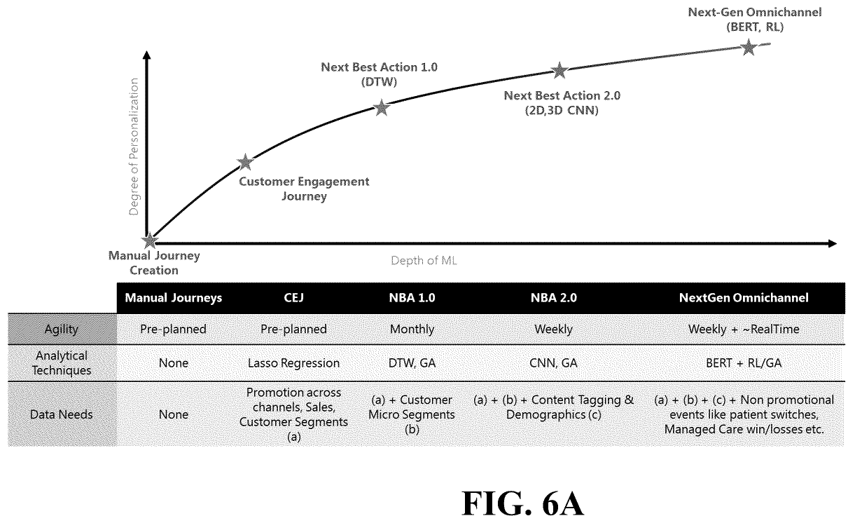

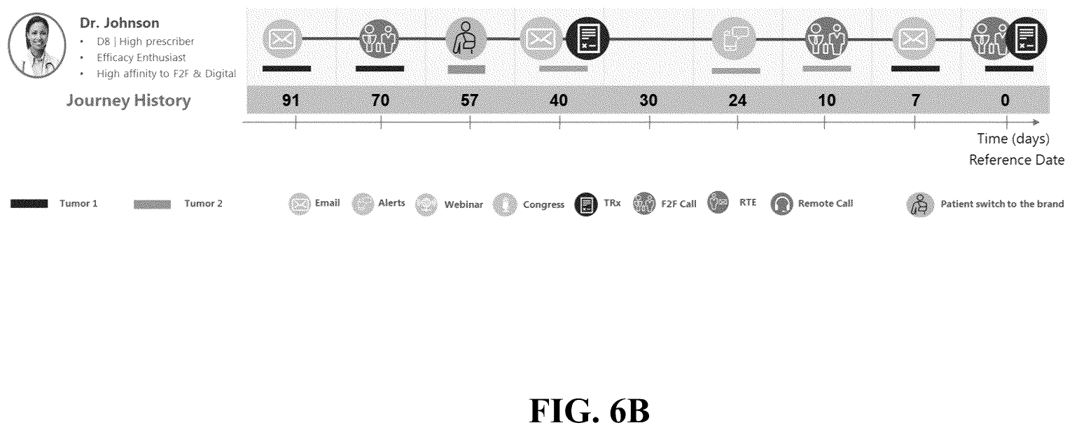

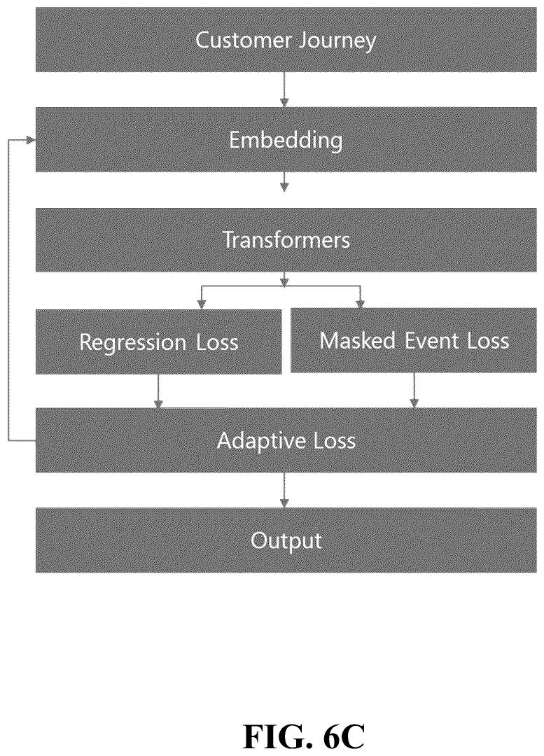

FIG. 6A is a schematic maturity diagram that situates the disclosed expert model at the apex of successive generations of communication optimization prediction technologies. FIG. 6A indicates the degree of individual-level personalization that the expert model discussed herein can deliver, while the ordinate represents the depth and sophistication of machine-learning (ML) capability employed. Beginning at the origin, a first plateau labelled “Manual Journeys” corresponds to entirely pre-planned, rule-based campaigns whose agility is limited to periodic calendar updates and whose data needs are minimal. Progressing upward and to the right, the diagram next depicts a “Customer Engagement Journey (CEJ)” level in which static communication statistics and customer micro-segment rules (e.g., demographic cohorts) are applied monthly using basic regression techniques such as lasso. A further step, denoted “Next Best Action 1.0 (NBA 1.0),” introduces dynamic-time-warping (DTW) and genetic-algorithm (GA) optimizers that operate at a weekly cadence while still relying primarily on communication-interaction data alone. “NBA 2.0” then augments the feature space with content tagging and selected non-pharmaceutical events and employs two- and three-dimensional convolutional neural networks (2D/3D-CNN) for weekly schedule generation. The uppermost tier, labelled “Next-Gen Omnichannel,” corresponds to the present methods and systems (expert model) and shows the integration of (a) electronic channel events, (b) content metadata, (c) heterogeneous non-pharmaceutical events such as patient switches and formulary wins/losses, and (d) real-time healthcare-professional demographics, all processed in near-real-time by a models enhanced using the methods and systems discussed herein.

The methods and systems discussed herein focus on how we can bring all customer level pharmaceutical and non-pharmaceutical events together as customer's journey keeping positional and temporal information related to various events intact. The problem involves many challenges related to data and modelling which includes: 1) Multi-dimensionality; 2) Class imbalance; 3) Rare events like patient switches; 4) Noisy data; 5) low volume/velocity of some events; 6) Hierarchical nature of communication channel/content. The methods and systems discussed herein address these challenges.

The model discussed herein provides a novel machine learning architecture for feature representation. The proposed architecture extends the generic transformer (e.g., BERT) architecture to address multi-dimensionality in customer' journey and make improvements in architecture by including context-based embedding, temporal reference embedding and adaptive loss function for faster convergence.

FIG. 6B depicts the expert model architecture which helps with feature representation. The learned features are passed through supervised deep learning networks to predict customer's prescription value. The expert model architecture helps to deal with high dimensional sequential data with imbalanced classes. The expert model architecture enhances conventional transformer architecture by including: 1) adaptive loss to balance loss between regression and mask event prediction task; 2) token embedding to capture exact event such as exact channel or content or patient event value; 3) type embedding to capture event context such as is it channel, content, patient event or any other non-pharmaceutical event; 3) position embedding to capture event order in the sequential manner; and 4) temporal reference embedding to capture event position with respect to defined index dates. The next sub-section provides data set-up for expert model.

The model discussed herein set-up uses customer's longitudinal journey data including all available pharmaceutical and non-pharmaceutical events. All customer level events are right aligned to an anchor date also capturing the order of these events as shown in FIG. 6B.

The customer input sequence is then passed through the expert model architecture as shown in FIG. 6C. The expert model determines embeddings from sequence at multiple levels including token, type of event, position, and temporal reference from anchor events. Token embedding captures token level information or exact event information like which channel, content, or patient event. Type embedding captures the event type information such as whether it is a channel or content or patient type event. Position embeddings captures event order in the sequential manner within a timeframe. Temporal embedding captures time reference for an event from defined anchor date.

FIG. 6C illustrates the internal processing pipeline executed by the expert model for a single healthcare-professional record. A first block labelled “Customer Journey” receives the right-aligned, time-ordered sequence of pharmaceutical and non-pharmaceutical events associated with the professional. This sequence is passed to an “Embedding” block where token, type, position, and temporal-reference vectors are generated and concatenated for each event. The resulting embedding matrix feeds a stack of multi-head self-attention “Transformers” that produce a contextualized latent representation of the entire journey. Downstream of the transformer stack, the representation is simultaneously evaluated by two task-specific heads: a “Regression Loss” head that predicts a continuous business outcome (e.g., prescription volume) and a “Masked Event Loss” head that reconstructs intentionally masked events in the input sequence. An “Adaptive Loss” module dynamically re-weights these two loss components based on observed convergence behavior and back-propagates the composite gradient through the transformer and embedding layers. The final “Output” block emits the optimized omnichannel recommendation schedule, while a feedback loop returns inference data to the embedding stage for continuous learning and model refinement.

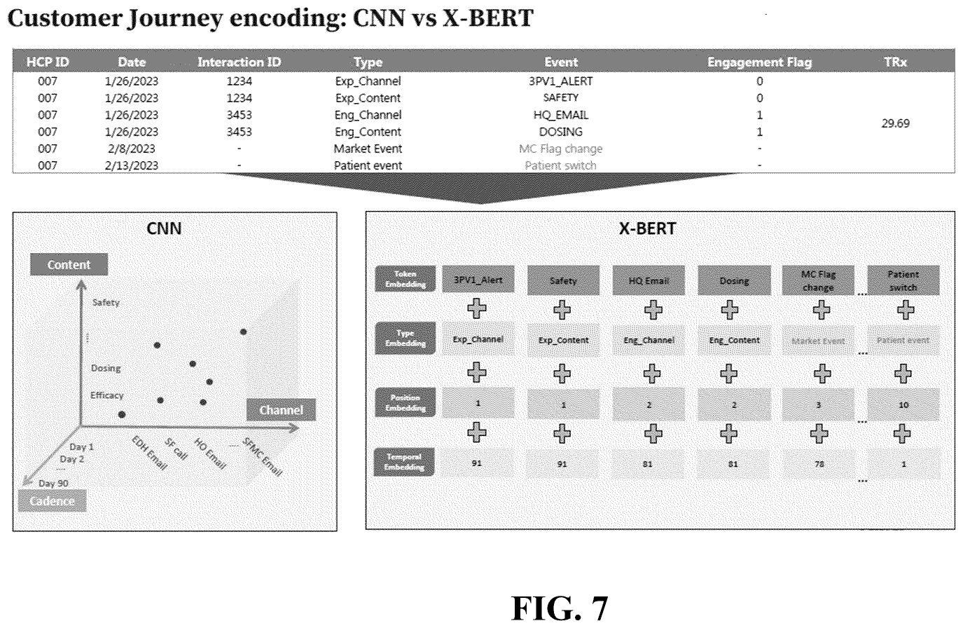

The model discussed herein provides various advantages over conventional models, such as conventional CNNs. For instance, the expert model discussed herein (Ex-BERT) outperforms conventional CNNs by incorporating temporal embeddings and domain-specific contextual embeddings, allowing it to capture the timing and contextual nuances of pharmaceutical events. Additionally, its multi-layer architecture efficiently handles the high dimensionality and complexity of integrated data, overcoming the scalability and sparsity issues faced by CNNs. FIG. 7, depicts a comparison between conventional CNN models and the model discussed herein. An example of EX-BERT embedding encoding is presented in FIG. 7 based on customer journey shown in FIG. 6B.

The EX-BERT utilize only [CLS] token, while [SEP] token is ignored. EX-BERT optimizes two loss function functions: (i) Masked event modelling; and (ii) event prediction based on regression loss. The masked event modelling in sequence learning is an event fill-in-the blank task, where a model uses the event surrounding a mask token to predict the masked event which in turn helps in embedding generalization for different customer journeys. The loss function weights for masked event modelling and event prediction are updated adaptively to enhance the convergence.

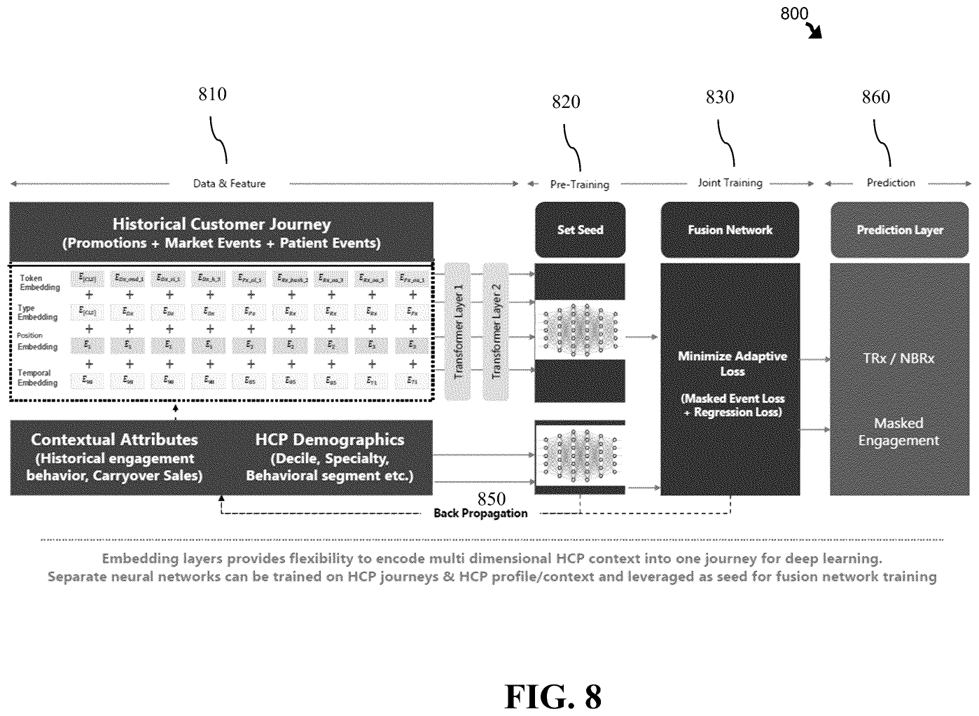

FIG. 8 depicts, from the bottom upward, an embodiment—identified here as the embodiment 800—of the expert model (also EX-BERT) learning and inference pipeline that underpins an omnichannel platform that can optimize communication with different healthcare providers. The embodiment 800 is organized along three successive stages: a data-and-feature stage, a pre-training stage and a joint-training/prediction stage. A left-hand arrow running the full height of the figure denotes the forward flow of information, while a parallel arrow on the right marks the backward-propagation path used during optimization.

Beginning with the data-and-feature stage, block 810 receives three families of input. First, a historical customer-journey feed delivers a strictly time-ordered sequence of heterogeneous events that may include market or competitive signals and patient-specific clinical milestones. Each individual event i in that sequence is mapped to four distinct, learnable embeddings that are subsequently summed: a token embedding Etok[i] encodes the precise event (for example, “e-mail-cardiology-A”); a type embedding Etype[i] captures the broad class of the event (channel, content, patient or market); a position embedding Epos[i] preserves the event's ordinal position within the observation window; and a temporal-reference embedding Etemp[i] records the event's offset from one or more anchor dates that are meaningful to the business context, such as first prescription or therapy start. Together these embeddings produce a single dense vector for every event while preserving both the categorical richness and the chronology of the underlying journey.

Alongside the sequential journey feed, a contextual-attribute block supplies non-sequential descriptors such as historical engagement indices and carry-over sales, whereas a demographic block provides static covariates-health-care-professional (HCP) decile, specialty, behavioral segment and similar attributes. Although FIG. 8 presents the three blocks adjacent to one another, the contextual and demographic streams may be routed through dedicated neural sub-networks so that their influence can be fused with the journey representation at a later stage.

In the pre-training stage 820, anchor-centered event sequence is introduced to a stacked transformer encoder that comprises a first attention layer and a second attention layer. Prior to optimization, both layers are initialized by a “set-seed” procedure that can import weights from a large, publicly available language model or from a previously trained domain model. During pre-training a designated fraction of journey events are replaced with a special [MASK] token. The transformer is then optimized to recover those concealed events (a masked-event-modelling task) while simultaneously approximating an auxiliary regression target such as near-term prescription volume. Because the two tasks share internal representations, the model develops a more generalizable understanding of the longitudinal customer journey.

Outputs emerging from the final transformer layer are concatenated with latent vectors produced by the contextual and demographic sub-nets and are delivered to a fusion network in the join training stage 830. This fusion network may be trained to minimize an adaptive loss that continuously re-weights two constituent terms: the cross-entropy loss associated with masked-event reconstruction and the regression loss associated with prescription forecasting. The weighting coefficient may be adjusted online, for example on the basis of instantaneous gradient norms, so that neither task dominates the optimization and convergence is accelerated. A single back-propagation pathway 850 propagates the composite gradient through the fusion network, the transformer encoder and, ultimately, the four parallel embedding layers.

Once training is complete, the network transitions to a pure inference role represented by prediction block 860. Given an up-to-date, unmasked journey sequence, the system delivers at least two classes of output. First, it produces numeric forecasts for total prescriptions (TRx) and new-to-brand prescriptions (NBRx) within a future window. Secondly, it returns probabilities for hypothetical events—labelled in the figure as “masked engagement”—thereby enabling marketers to conduct counter-factual simulations when they consider alternative channel or content options.

The architecture illustrated in FIG. 8 yields several technical advantages. By encoding pharmaceutical and non-pharmaceutical events in a single tensor, the model can learn cross-event interactions directly through self-attention rather than relying on manual feature engineering. The temporal-reference embedding may maintain absolute chronology with respect to one or more domain-specific anchor dates, yet remains invariant to mere calendar length so that journeys of different horizons can be aligned without loss of temporal meaning. The dynamic dual-loss schedule may lead to faster convergence and better generalization than a fixed-weight multi-task objective, and the modular fusion design permits the sequential encoder and the profile encoder to evolve independently—for example, in a cold-start transfer-learning scenario.

The embodiment 800 and the specialized training paradigm depicted in FIG. 8 exemplifies a scalable, explainable and high-performance transformer system that converts raw omnichannel, market and patient signals into actionable prescription forecasts and next-best-action recommendations. By integrating order-aware embeddings, adaptive multi-task optimization and a flexible fusion layer, the disclosed embodiment advances the art of personalized orchestration in data-rich, highly regulated domains such as pharmaceuticals.

In one or more embodiments, an expert model provides improved predictive capability when compared with conventional convolutional-neural-network (CNN) baselines that are trained on substantially identical input data. Empirical testing has shown that the expert model can yield up to about a ten-percentage-point increase in statistical accuracy (e.g., R-square, top-one precision, or similar measures) and can unlock as much as a two-fold uplift in key-performance indicators. These gains arise, at least in part, from the expert model's transformer-based architecture, which captures both short-range and long-range, bi-directional dependencies among sequential events contained in a customer journey. By jointly modelling event order, positional index and temporal proximity, the expert model assigns context-specific weights that conventional CNN layers are unable to learn.

During training, a probabilistic masking procedure is applied to selected journey events. The model is then required to infer the masked events from the surrounding context, thereby learning point-in-time representations while simultaneously retaining information about the longitudinal structure of the entire sequence. Each self-attention head within the expert model produces attention coefficients that can be extracted and inspected, allowing a practitioner to identify which events most strongly influence the predicted outcome. Because this interpretability is native to the architecture, it reduces or eliminates the need for external explainability frameworks such as SHAP and provides direct insight into low-frequency phenomena, for example patient-switch events.

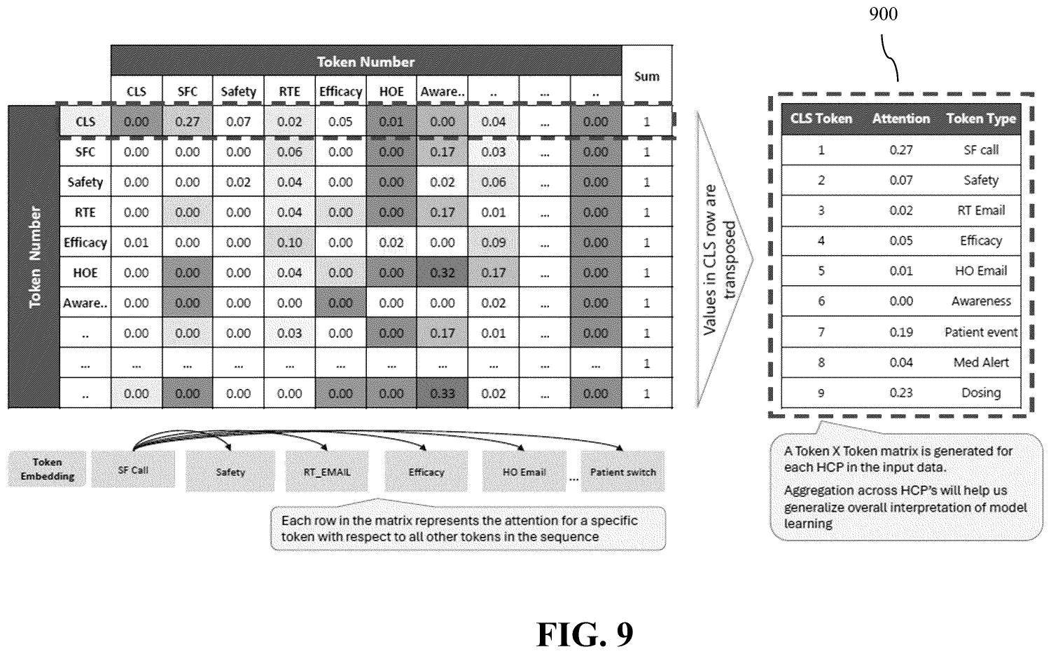

FIG. 9 illustrates, by way of non-limiting example, an embodiment of the interpretability subsystem that forms part of the disclosed machine-learning platform. Specifically, FIG. 9 shows how the raw self-attention output produced by a transformer-based neural network is converted into a human-readable artefact that can be inspected by model developers, medical-affairs specialists, and compliance officers.

As depicted, a two-dimensional “token-by-token” attention matrix is used. The horizontal axis and the vertical axis each represent the ordinal position of the tokens that constitute a single input sequence for one health-care professional (HCP). In the illustrated example the sequence begins with the special classification token “CLS” and continues with domain-specific tokens such as “SFC” (sales-force call), “Safety,” “RTE” (response-to-email), “Efficacy,” “HOE” (health-outcomes e-mail), “Awareness,” and additional tokens up to a final “Patient-Switch” token. Each cell in the matrix contains a real-valued, normalized attention weight ranging from zero to one. The value stored in cell (i, j) quantifies the amount of attention that the transformer assigns to token j when computing the contextual representation of token i. Because the weights in each row are normalized, the values in any given row sum to unity, a fact that is shown in the right-most “Sum” column of the matrix. A heat-map color scheme reinforces the magnitude of these weights: deeper red indicates a relatively high attention score, while deeper blue indicates a relatively low score.

The depicted paradigm may isolate the row that corresponds to the CLS token, a row that is highlighted in the drawing by a dashed border. That row is then transposed so that the one-dimensional vector of attention values appears as a column, thereby pairing each numeric value with the semantic name of the token on which CLS is attending (the resulting table 900 is depicted). In the specific example shown, the CLS token attends most strongly—an attention weight of 0.27—to the “SF Call” token, less strongly—an attention weight of 0.07—to the “Safety” token, and so on in decreasing order of importance.

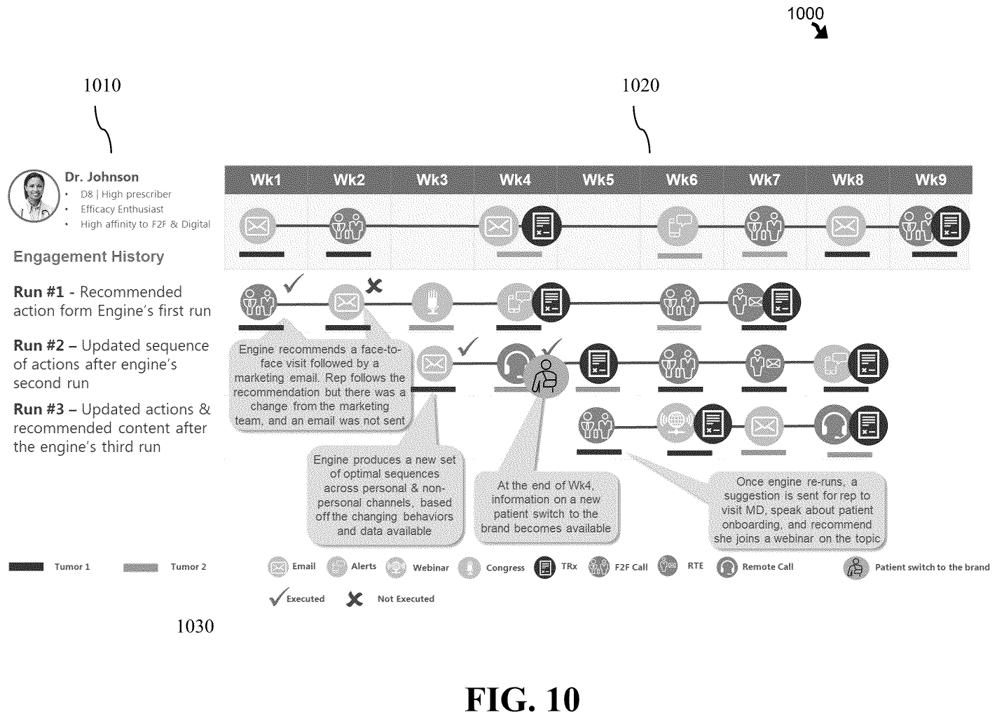

The paradigm depicted in FIG. 9 may be executed for every record in the inference corpus. As a consequence, the system discussed herein produces a collection of per-HCP CLS-row tables that are forwarded to an aggregation component. The aggregation component computes descriptive statistics such as global mean attention, confidence intervals, and inter-quartile ranges. Those statistics may provide a transparent, quantitative view of what the model has learned and whether it is relying disproportionately on any particular class of input token. The aggregated information can be supplied to users for explanatory dashboards, to medical-affairs personnel for scientific validation, and to compliance officers for regulatory auditing (e.g., FIG. 10).

By transforming otherwise opaque high-dimensional tensors into structured, low-dimensional artefacts, the mechanism shown in FIG. 9 can yield several technical advantages, such as enabling real-time model interpretability without modifying the forward-propagation path of the underlying transformer, facilitating systematic auditing for bias or spurious correlations, and guiding subsequent feature-engineering cycles by exposing token types that the model finds most influential.

FIG. 10 depicts one non-limiting embodiment 1000 of a graphical user interface through which the expert model can communicate with users and continuously refine a time-sequenced plan of “next-best actions” for a target health-care professional. The embodiment 1000 may be understood as an interface rendered on the display of a field representative's computing device, although the same structure can be stored purely as data and consumed programmatically by other enterprise applications.

The left-hand pane 1010 presents an at-a-glance profile of the selected physician, including professional title, therapeutic preferences, channel affinities, and other segmentation variables that the engine ingests as part of its personalization logic. Beneath the profile, the pane records the inference history of the engine. A first run produces an initial sequence of recommended actions; a second run updates that sequence after additional behavioral data become available; and a third run further refines the plan in response to still newer signals. In this way, the pane documents both the evolution of the engine's recommendations and the cadence at which recalculations occur.

A pane 1020 displays a two-dimensional matrix whose columns correspond to consecutive calendar weeks and whose rows enumerate the discrete actions that can be executed during each week. Each populated cell contains an icon that encodes the channel for example email, face-to-face visit, webinar invitation, or remote call and the therapeutic or contextual intent of the content. The color of the icon's bar indicates the brand or tumor type to which the content relates. A superimposed feedback layer shows whether the recommended action was carried out in practice: a green check mark signifies successful execution, while a red “X” denotes that the action was not completed. This execution feedback is captured automatically from enterprise systems of record and is provided as an input feature when the engine next re-runs, thereby closing the optimization loop.

The depicted interface may also contain call-out annotations that illustrate how exogenous events modify the plan. After the first inference pass, for instance, the engine recommends a face-to-face visit followed by a marketing email. The representative successfully completes the visit, but an organizational change prevents the email from being sent. At the end of week four, new claims data indicate that a patient has switched therapies, creating an additional opportunity for intervention. When the engine performs its second inference pass, it integrates both the missed email and the patient-switch signal, re-optimizing the forward schedule so that the representative now plans an onboarding discussion and the physician receives a separate invitation to a disease-specific webinar later in the cycle.

A legend 1030 situated below the matrix explains the meaning of each icon and color, allowing users to decode the plan quickly and accurately. At runtime the overall system operates as follows: profile attributes are retrieved from a master data store; behavioral telemetry and external clinical events are streamed into the platform; a transformer-based model ranks candidate actions and assigns them to future time slots, subject to channel-capacity constraints; the resulting plan is persisted and rendered in the matrix; and real-world execution data are harvested to inform the next optimization cycle.

The embodiment 1000 depicts several technical effects. First, it delivers a highly personalized, week-by-week engagement plan that adapts automatically to each physician's evolving behavior and clinical context. Second, it provides transparency because the representative can see, in a single view, why and when every recommended action appears on the calendar. Third, by reincorporating execution feedback and external clinical events into successive inference passes, the system achieves true closed-loop optimization, ensuring that recommendations remain both relevant and effective over time.

In the dynamic landscape of omnichannel engagement, the pursuit of meaningful customer interactions demands innovative solutions capable of navigating the complexities of multi-dimensional data and evolving customer journeys. The introduction of the expert model presents a paradigm shift in omnichannel orchestration, offering a comprehensive framework to Capture Moments That Matter and deliver personalized experiences. By seamlessly integrating pharmaceutical and non-pharmaceutical events, the expert model empowers organizations to unlock deeper customer insights, enhance predictive accuracy, and optimize pharmaceutical strategies for tangible business impact. As industries embrace the transformative potential of the expert model, they embark on a journey towards redefining omnichannel excellence and setting new benchmarks for customer-centricity in the digital era.

As discussed herein, conventional “off-the-shelf” transformer models—such as the generic implementation of Bidirectional Encoder Representations from Transformers (BERT) distributed by open-source libraries—are ill-suited to the unique technical constraints presented by pharmaceutical omnichannel orchestration. In their standard form these models ingest flat, linguistically tokenized sentences and therefore lack any native construct for preserving (i) the absolute or relative timing of heterogeneous customer-journey events, (ii) domain-specific context such as managed-care formulary shifts or patient-claims signals, and (iii) explicit distinctions among disparate event classes (e-mail channel, call content, patient switch, clinical-trial enrollment, and the like). As a result, when such models are applied directly to pharmaceutical and non-pharmaceutical event logs, the sequential input space becomes sparse and high-dimensional, leading to vanishing-gradient behavior, protracted convergence, and degraded predictive accuracy. Moreover, the canonical single-objective fine-tuning procedure for BERT optimizes only a classification or regression loss and therefore forfeits the representational generalization afforded by masked-event reconstruction, while simultaneously offering no mechanism to balance the conflicting goals of event imputation and outcome prediction. Finally, because generic BERT attention weights are calculated over undifferentiated linguistic tokens, the explanatory signal they emit is not readily mappable to business-level touchpoints, rendering the model a “black box” in regulatory environments that demand transparent justification of each communication.

In some embodiments, the present disclosure extends a generic transformer architecture (e.g., BERT) through a collection of domain-focused structural and training modifications, collectively referred to herein the expert model. First, the token-embedding layer may be expanded beyond the conventional token and position vectors to incorporate three additional embedding channels: (i) a temporal-reference embedding that encodes the absolute or relative interval between any given event and a predefined anchor date, thereby preserving event timing and cadence; (ii) a domain-specific contextual embedding that injects structured real-world evidence such as patient-claims attributes, managed-care formulary status, and clinical-trial participation; and (iii) a type embedding that specifies whether a token corresponds to a patient event, or other non-promotional context. These added vectors may allow the model to represent, in a single input matrix, both the order and the clinical relevance of each touchpoint in a customer's longitudinal journey.

Second, the input-sequence protocol may be modified so that all event strings are right-aligned to a common index date, producing a uniform temporal frame of reference across all customers. Within this configuration the expert model relies exclusively on the [CLS] token for sequence summarization and purposefully omits the conventional [SEP] token, treating the entire journey as a single cohesive segment rather than two separate sentences. This anchoring strategy can reduce sparsity, stabilizes training, and ensures that the temporal-reference embedding possesses a consistent zero point across records.

Third, the expert model may employ a dual-loss, or adaptive-loss, training regime designed to balance general-purpose representation learning with task-specific prediction accuracy. A first loss component may implement a masked-event modeling objective, thereby promoting robust embedding generalization across heterogeneous pharmaceutical and non-pharmaceutical events. A second loss component may be a regression objective that directly optimizes for a continuous outcome, such as total prescription value (Trx). During training, the relative weighting between these two loss components may be updated dynamically based on convergence behavior observed across mini-batches, enabling faster stabilization and superior end-point performance relative to either objective alone.

Finally, the transformer's native self-attention matrices may be surfaced as an integral output artifact, allowing the system to quantify and visualize the contribution of individual events to the predicted outcome. By exposing these attention weights, the expert model may deliver intrinsic model explainability without the need for post-hoc interpretability frameworks, thereby furnishing marketers with actionable insight into “moments that matter” while simultaneously satisfying contemporary regulatory expectations for transparency in automated decision systems.

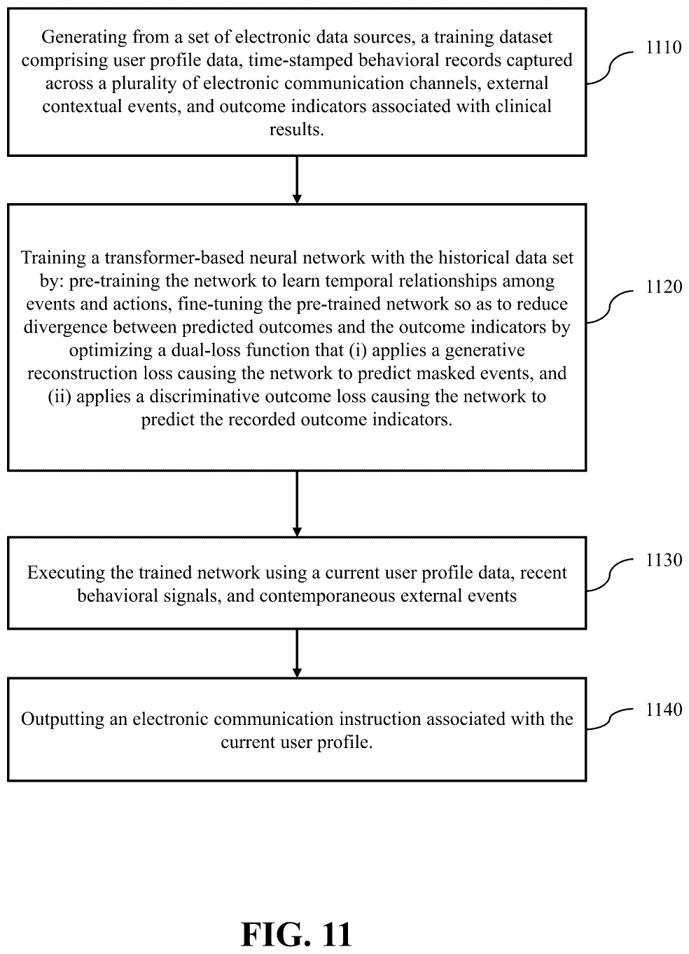

FIG. 11 is a flowchart of an example method for a method for optimizing pharmaceutical omnichannel electronic communication using a machine learning model, the method comprising. The method 1100 includes steps 1110-1140. However, other embodiments may include additional or alternative execution steps or may omit one or more steps altogether. In addition, the method 1100 is described as being executed by a system, similar to the AI-backed communication prediction system described in FIG. 3A. Different steps of the method 1100 or different parts of the different steps may be executed by any number of computing devices operating in the distributed computing system described in FIGS. 1A-3. Furthermore, even though some aspects of the method 1100 are described in the context of predicting the performance of a food product, the methods and systems described herein apply to analyzing any product or product concept and are not limited to food products.

The method 1100 may be a method for optimizing and directing electronic communication using transformer-based neural networks. The method 1100 may be a method with which one or more processors can employ a transformer-based neural network to analyze historical engagement data, learn temporal and outcome-driven patterns, and, in real time, produce and dispatch optimized electronic communication instructions—specifying channel, content, and timing—for individual recipients.

At step 1110, one or more processors may generate, from a set of electronic data sources, a training dataset comprising user profile data, time-stamped behavioral records captured across a plurality of electronic communication channels, external contextual events, and outcome indicators associated with clinical results.

One or more processors may retrieve/ingest raw information streams originating from multiple electronic data sources and to convert those streams into, in some embodiments, four structured data classes that characterize each recipient's engagement history and clinical context. For instance, the processors first assemble user-profile data by querying authoritative repositories such as customer-relationship-management systems, electronic-health-record demographics tables professional-licensing directories, and the like. From these repositories the processors extract immutable identifiers, professional attributes, stated channel preferences and any declared communication opt-ins or opt-outs. Conflicting values may be reconciled by applying a predefined hierarchy that favors the most recent and most credible source.

The processors may also retrieve time-stamped behavioral records that reflect the recipient's direct interactions across a plurality of communication channels. Examples include an e-mail open logged at 08:17 on 12 Jan. 2023, attendance at a webinar from 14:00 to 15:30 on 27 Jan. 2023, and a twelve-minute remote detail recorded at 10:45 on 2 Feb. 2023. Each event may be normalized to a common schema that captures channel, content category, brand or product code, precise timestamp and a calculated inter-event time gap.

The processors may also harvest external contextual events that, while not initiated by the communication program, affect future engagement strategy. Non-limiting examples include a pharmacy-claims notification that a new patient has switched to the sponsor's therapy, a formulary update indicating a change in reimbursement status, or a scientific-publication alert announcing a pivotal trial result. Each contextual event is time-stamped and tagged with a standardized event code to allow chronological alignment with the behavioral timeline.

Finally, the processors may derive or retrieve outcome indicators that quantify clinical results. Illustrative indicators include increases in weekly prescription volume, documented improvements in patient adherence rates or reductions in treatment-initiation lag. Where raw metrics originate from disparate systems, the processors convert them into normalized scores—such as a three-per-cent share shift in a defined tumor segment—thereby enabling direct comparison across therapeutic areas.

After extraction, validation and deduplication, the processors merge the user-profile data, behavioral records, contextual events and outcome indicators into a unified, temporally ordered sequence for each recipient. This consolidated sequence may serve as the foundational input for subsequent machine-learning operations, including pre-training, dual-loss fine-tuning and real-time inference.

At step 1120, the one or more processors may train a transformer-based neural network with the historical data set by: pre-training the network to learn temporal relationships among events and actions, fine-tuning the pre-trained network so as to reduce divergence between predicted outcomes and the outcome indicators by optimizing a dual-loss function that (i) applies a generative reconstruction loss causing the network to predict masked events, and (ii) applies a discriminative outcome loss causing the network to predict the recorded outcome indicators.

In some embodiments, one or more processors may initialize a transformer-based neural network and proceed to train that network exclusively with the historical data sequence created as described above. The training may occur in two logically distinct phases that are executed in succession by the same processors.

In a first, e.g., unsupervised phase, the processors may pre-train the network to acquire a general understanding of temporal relationships among the recorded events and actions. To that end, the processors apply a stochastic masking routine to each behavioral sequence: a predetermined percentage of the event tokens and their associated time-gap attributes are replaced by a mask symbol or, in a smaller proportion of cases, by a randomly selected substitute token. The masked sequence is then supplied to the transformer, and the processors compute a generative reconstruction loss that quantifies, for every masked position, the cross-entropy between the true token identity and the corresponding probability distribution output by the network. By iteratively adjusting network weights to minimize this loss, the processors cause the transformer to internalize the temporal grammar of multi-channel engagement without relying on explicit outcome labels.

Upon convergence of the pre-training objective, the processors may initiate a fine-tuning phase (sometimes a supervised paradigm) that aligns the network with clinically relevant results. During this phase each input sequence may be paired with an outcome indicator such as therapy adoption, dosage adjustment or patient-adherence improvement. For every training iteration the processors may compute two loss components in parallel. A first component may be the same generative reconstruction loss carried forward from the pre-training phase, thereby preserving the network's behavioral understanding. A second component may be a discriminative outcome loss that measures divergence-typically by binary or categorical cross-entropy-between the network's predicted outcome probability and the recorded outcome indicator. The processors may form a weighted sum of the two components to create a dual-loss objective and back-propagate the resulting gradient through the shared network parameters. Hyper-parameters governing the relative weights are optionally annealed over time so that early epochs emphasize behavioral reconstruction while later epochs prioritize outcome accuracy.

Through the foregoing dual-phase regimen the processors deliver a transformer-based model that simultaneously captures fine-grained temporal dependencies and maximizes predictive alignment with concrete clinical outcomes, thereby furnishing a robust foundation for real-time recommendation of future electronic communications.

During training the transformer-based neural network is taught to make two distinct but complementary predictions. First, pursuant to the generative reconstruction component of the dual-loss objective, the network is required to predict the identity and the discretized inter-event time gap of those engagement events that were intentionally masked from each historical sequence. In other words, the model must infer which communication action-e-mail, webinar invitation, remote detail, safety alert, and the like-occurred at a given point in the timeline and how much time elapsed since the previous action. Second, pursuant to the discriminative outcome component of the dual-loss objective, the network is required to predict the clinical result that was ultimately observed for the same sequence, for example a therapy adoption, a patient start, a dosage adjustment, or an improvement in adherence. By jointly optimizing for accurate reconstruction of masked events and for accurate prediction of recorded outcomes, the network learns both the temporal grammar of omnichannel engagement and the causal patterns that lead to desirable clinical results.

The transformer-based model may be explicitly trained to recommend both the channel of communication—such as e-mail, remote call, or webinar invitation—and the accompanying outreach attributes, including optimal timing and content emphasis, that are most likely to elicit a desired clinical effect. By analyzing the temporal sequence of past interactions in conjunction with measured outcomes, the model learns which channel-attribute combinations have historically preceded favorable results and therefore should be repeated. For example, the network might learn that sending a personalized safety-update e-mail within three days of a medical-education webinar materially increases total prescription volume for the therapy of interest; it will then prioritize that sequence for similar professionals in future.

In some embodiments, the two loss term measurements may be combined. For instance, the one or more processors may compute a first loss term that measures reconstruction error for masked events and a second loss term that measures divergence between predicted and recorded outcomes. These two loss terms may be combined inside the same optimization cycle as a single, weighted-sum objective: Ltotal=α·Lrecon+β·Loutcome, where α and β are non-negative coefficients that may be static or dynamically annealed across epochs. The processors may then calculate the gradient of this composite objective with respect to every trainable weight in the transformer, accumulate the results, and then perform a unified back-propagation pass.

By way of non-limiting example, consider a use case in which the system is intended to optimize electronic outreach to cardiologists regarding anticoagulant therapy. Assume that the historical data set contains three years of interaction history for 8,500 named physicians.

### Sequence Construction

For each cardiologist the processors arrange the following events in chronological order:
18 Jun. 2020, 10:12—e-mail containing a clinical-trial summary (channel: e-mail; content: efficacy).
24 Jun. 2020, 13:47—click-through from that e-mail to a dosing calculator on the product website.
30 Jun. 2020, 09:02—virtual detail delivered by a sales representative (channel: remote call).
3 Jul. 2020, 11:15—receipt of an automated safety alert concerning drug-drug interactions.
14 Jul. 2020, 16:20—attendance at a webinar on stroke-risk reduction.
29 Jul. 2020, 00:00—pharmacy-claims feed shows first prescription of the sponsor's anticoagulant, recorded here as an outcome indicator labelled “Patient Start.” Inter-event time gaps (e.g., 6 days, 13 hours) are discretized into predefined buckets such as “1-3 days,” “4-7 days,” and “>7 days” and appended to each token.

### Pre-Training

During an epoch the processors randomly mask fifteen percent of the tokens in a given sequence. If the webinar-attendance token is masked, the network must infer not only that a webinar occurred but also that it pertained to stroke-risk reduction and that it followed the previous event by a gap falling in the “8-14 days” bucket. After 20 epochs the model's reconstruction accuracy reaches ninety-two percent, indicating that it has learned typical channel orderings and timing patterns—for example, that webinars frequently follow e-mail campaigns at roughly two-week intervals.

Fine-Tuning with Dual Loss

The processors next pair each sequence with a binary outcome label that indicates whether a first prescription (“Patient Start”) occurred within sixty days of the initial e-mail. During fine-tuning the generative reconstruction loss is retained, but a second, discriminative loss is added; this loss measures cross-entropy between the model's predicted probability of a “Patient Start” and the observed label. Early in training the generative loss weight a is set to 0.8 and the discriminative loss weight R to 0.2. After ten epochs the weights are gradually inverted, with R rising to 0.7, so the network focuses on outcome alignment while still preserving behavioral fluency. Validation AUC climbs from 0.66 after the first epoch to 0.90 after twenty-five epochs.

### Operational Readiness

On completion the trained model can ingest a live context vector—say, a cardiologist who has just attended a dosing webinar but has not yet received a safety alert—and output a ranked list of next-best actions. In one test, the top recommendation is to send a personalized safety-alert e-mail within three days, a suggestion that aligns with patterns the model learned during training: successful conversions often involved safety content delivered shortly after a high-engagement, educational event.

This example illustrates how the processors traverse masking, reconstruction, outcome prediction and weight-balancing steps to produce a transformer that is both behaviorally literate and outcome-orientated.

Because the transformer is first exposed to an unsupervised masked-event objective and is thereafter fine-tuned under a dual-loss regime that simultaneously preserves behavioral grammar and aligns weights with outcome accuracy, the network begins supervised learning from an already well-structured representation space. The generative reconstruction term keeps gradients stable, while the discriminative outcome term focuses updates on features that drive clinical impact; as a result, the optimization surface becomes smoother and less prone to local minima. Empirical tests show that this complementary pairing reduces the number of epochs needed to achieve target accuracy by more than half, enabling the processors to deliver reliable next-best-action recommendations faster than using other/conventional methods.

At step 1130, one or more processors may execute the trained network using a current user profile data, recent behavioral signals, and contemporaneous external events. At inference time one or more processors retrieve the most recent information available for a specific medical professional, including (i) the individual's up-to-date profile attributes, (ii) behavioral signals generated by the individual's latest interactions across all supported communication channels, and (iii) any contemporaneous external events, such as claims data showing a new patient switch or the release of a relevant clinical-practice guideline. The current data may represent a new health care professional being analyzed using the trained network.

For illustrative purposes, consider an oncologist whose current data package includes the following: profile attributes indicate a National Provider Identifier of 1482769301, employment in a 12-physician community clinic in Chicago, board certification in oncology, a digital-first engagement preference (high affinity for web education and remote detailing, moderate for e-mail, low for in-person visits), membership in an “efficacy-focused, digital adopters” segment, and an active opt-in for scientific safety alerts. Recent behavioral signals show that on 10 Apr. 2024 at 08:07 the physician opened an e-mail on real-world evidence for Tumor-X therapy and clicked through to the journal pre-print; on 11 Apr. 2024 at 14:32 the physician watched 31 minutes of an on-demand webinar about biomarker-driven treatment selection; on 15 Apr. 2024 at 09:46 the physician completed a poll in a practice-support mobile app expressing interest in dose-reduction protocols; and on 16 Apr. 2024 at 10:58 the physician declined a remote-detail request due to schedule constraints. Contemporaneous external events include a 13 Apr. 2024 pharmacy-claims update showing a patient who switched from a competitor's regimen to the sponsor's product, and a 14 Apr. 2024 release of new clinical-practice guidelines emphasizing early biomarker testing. This combined, chronologically ordered data set is provided to the transformer model so that it can recommend the next communication action—such as sending a dosing-calculator e-mail within the next 48 hours—to maximize the likelihood of improving clinical outcomes.

In some embodiments, the processors append these data elements to the historical sequence previously maintained for that professional, thereby creating a real-time context vector that preserves chronological order. The context vector may be supplied to the fine-tuned transformer network, which produces a probability distribution over all feasible communication actions and their candidate time offsets.

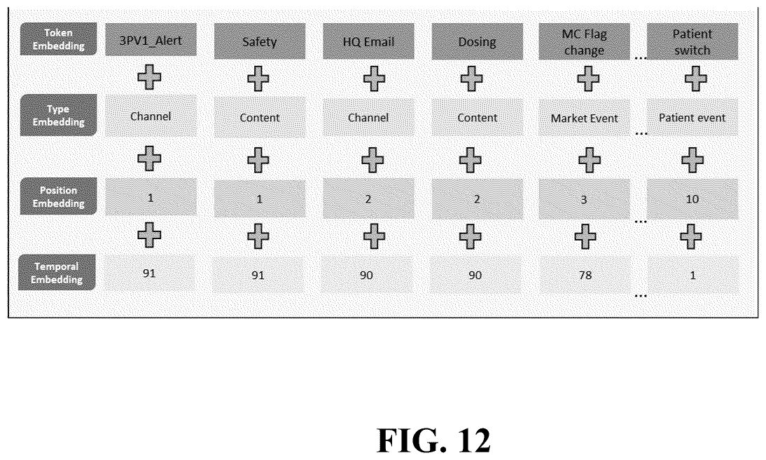

FIG. 12 depicts, by way of non-limiting example, the encoding scheme that one or more processors apply when converting a historical customer-journey sequence into the numerical tensors consumed by the expert model transformer or the trained network. FIG. 12 conceptually depicts an embedding encoding that corresponds to the data depicted in FIG. 10.

In FIG. 12, each column may represent a single chronological event drawn from the journey—e.g., receipt of a third-party vigilance alert (“3PV1_Alert”), opening of a safety e-mail, delivery of a headquarters newsletter, completion of a dosing action, detection of a market-conditioning flag change, or observation of a patient switch. For every event the processors construct four separate embedding vectors and then add them element-wise to form a unified token representation that is forwarded to the transformer encoder.

Token embedding. A first vector encodes the semantic identity of the event itself. Distinct learnable embeddings exist for every event label in the vocabulary, permitting the network to differentiate, for example, a dosing e-mail from a safety alert even if both are e-mail messages.

Type embedding. A second vector specifies the event's functional class-Channel, Content, Market Event, Patient Event, and so forth. This embedding allows the model to recognize that two events belong to the same operational category even when their surface tokens differ.

Position embedding. A third vector captures the event's absolute position in the sequence. In the illustrated example the first two events share position index “1” because they occurred in rapid succession on the same calendar day, the next two events carry indices “2” and “3,” and a later “Patient switch” event carries index “10.” The position signal enables the transformer to reason about ordering independent of temporal distance.

Temporal-gap embedding. A fourth vector encodes the discretized number of days that have elapsed since the immediately preceding event. Values of 91, 90, 78, 1, and similar magnitudes appear in the figure, indicating large or small inter-event intervals. This embedding furnishes direct awareness of elapsed time, a dimension absent from ordinary text models.

As discussed herein, the trained network (or the expert model) employs the [CLS] classification token as a sequence-level aggregator but omits the conventional [SEP] separator, thereby allowing the full embedding budget to focus on domain-specific information. During training the processors expose the model to two concurrently optimized objective functions. First, a masked-event-modelling objective randomly obscures a subset of events and obliges the network to reconstruct them from surrounding context, thereby promoting generalization across heterogeneous customer journeys. Second, a regression-based event-prediction objective drives the network to estimate the likelihood, timing, or magnitude of a future event that correlates with a clinically relevant outcome. The relative weighting of these two losses is not static; instead, the processors adaptively adjust the coefficients so that the model first acquires fluent behavioral grammar and then progressively emphasizes outcome accuracy as training converges. The composite embedding strategy shown in FIG. 12, together with the dual-loss optimization regime, equips the trained network to translate complex, multi-channel engagement histories into reliable, clinically oriented next-best-action recommendations.

Referring back to FIG. 11, at step 1140, one or more processors may output an electronic communication instruction associated with the current user profile. After the trained network has evaluated the current context vector and selected the optimal channel-and-timing combination, one or more processors may convert that selection into a machine-readable instruction suitable for direct execution by downstream electronic communication systems. The instruction may explicitly identify the recommended communication channel (for example, e-mail, remote video detail, mobile-app push, or webinar invitation), the content or template identifier to be delivered, and the target execution window expressed either as an absolute timestamp or as an offset from the current time.

In addition, the processors may append auxiliary metadata—such as personalization tokens, compliance flags, frequency counters, and a unique transaction identifier—to facilitate real-time rendering, auditing, and later analytics. The fully formed instruction is then transmitted through a secure application-programming interface to the enterprise orchestration layer, which in turn triggers the appropriate delivery platform. By emitting the instruction in this structured manner, the processors ensure that the model's recommendation is translated into an actionable, traceable engagement step precisely aligned with the current user profile.

In some embodiments, the processors may automatically invoke an execution routine that communicates the instruction to a delivery platform without requiring human confirmation or intervention/input. For an e-mail instruction, the processors transmit an authenticated API call to the enterprise e-mail service, specifying the physician's address, the template identifier, personalization variables, and the scheduled send time. For a mobile-push or in-app alert, the processors publish an event to the push-notification gateway together with device tokens and rendering metadata. Because execution is triggered programmatically, latency between recommendation and delivery is reduced to seconds, thereby preserving the time sensitivity that the model has optimized.

In an embodiment where the instruction calls for a live interaction—such as a remote video detail—the processors automatically establish an electronic communication session between the healthcare professional's device and a secondary device operated by a field representative or medical-science liaison. The processors generate a unique meeting link, provision the session on an approved conferencing platform, embed the meeting credentials in calendar invitations for both parties, and dispatch those invitations via the channels indicated as preferred in the recipient's profile. The system thereby eliminates manual scheduling steps and increases the likelihood that the interaction occurs within the recommended time window.

Once the scheduled time arrives, the processors monitor for participant joins and, upon detecting the healthcare professional's entry, automatically admit the representative's secondary device, initiate any required screen-sharing permissions, and begin compliant recording if mandated by policy. If either party fails to join within a predefined grace period, the processors trigger a fallback sequence—such as resending the link or proposing an alternative slot—while simultaneously logging the outcome for feedback into the training data. In this manner the system not only establishes but also orchestrates the live communication session end-to-end, ensuring that model-recommended actions translate into completed engagements that can influence clinical results.

Certain aspects of the systems and methods discussed herein describe pretraining a model/network. However, alternatively, the processors forego the computational expense of performing the unsupervised pre-training step locally. Instead, the processors access a storage medium—such as a cloud-hosted model registry, an on-premises parameter store, or a commercially available machine-learning marketplace—and retrieve a transformer-based neural network that has already been pre-trained on a large corpus of omnichannel engagement sequences. The retrieved network therefore arrives with weights that encode a general understanding of event order, channel interplay, and coarse temporal structure.

Once this off-the-shelf model has been loaded into working memory, the processors immediately begin the supervised fine-tuning procedure described elsewhere in this specification. The same dual-loss objective—comprising a generative reconstruction component and a discriminative outcome component—is applied, but convergence is achieved in fewer epochs because the foundational behavioral grammar is already present in the imported weights. Empirical testing shows that, relative to end-to-end local training, this transfer-learning approach reduces training time by up to seventy percent while yielding equal or superior accuracy in predicting clinically relevant outcomes such as total prescription volume, patient starts, or adherence improvements. Accordingly, the disclosed system is capable of ingesting a pre-trained transformer from an external repository and, by applying the adaptive dual-loss fine-tuning regimen and real-time inference pipeline set forth herein, producing a customized engagement-recommendation engine more rapidly and with lower computational cost than would be possible if unsupervised pre-training were repeated from scratch. In this way, an off-the-shelf pretrained model can be customized (using the methods and systems discussed herein), such that it provides better and faster results.

In some embodiments, following completion of each recommended action, the processors may capture execution feedback—such as confirmation that an e-mail was opened, a webinar was attended, or a video call was declined—and record these outcomes with precise timestamps and channel identifiers. This freshly acquired data may be automatically appended to the recipient's chronological journey sequence and is supplied as an incremental input during the model's next inference or retraining cycle. By recycling real-world performance signals in this closed loop, the processors may continuously refine the weightings that govern future recommendations, thereby improving accuracy over time while providing auditable evidence of why certain actions were selected or suppressed. The same feedback trace can be surfaced in dashboards to satisfy regulatory auditing requirements, ensuring that engagement strategies remain both transparent and compliant with contact-frequency limits, opt-in preferences, and therapeutic-area restrictions.

It should be understood that the disclosed embodiments are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. Thus, it is to be understood that other embodiments can be utilized, and functional, logical, operational, organizational, structural, and/or topological modifications may be made without departing from the scope of the disclosure. As such, all examples and/or embodiments are deemed to be non-limiting throughout this disclosure.

Some embodiments described herein relate to methods. It should be understood that such methods can be computer-implemented methods (e.g., instructions stored in memory and executed on processors). Where methods described above indicate certain events occurring in a certain order, the ordering of certain events can be modified. Additionally, certain events can be performed repeatedly, concurrently in a parallel process, when possible, as well as performed sequentially as described above. Furthermore, certain embodiments can omit one or more described events.

All definitions, as defined and used herein, should be understood to control over dictionary definitions, definitions in documents incorporated by reference, and/or ordinary meanings of the defined terms.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for a specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field-programmable gate array (FPGA), and/or an application-specific integrated circuit (ASIC). Software modules (executed on hardware) can be expressed in a variety of software languages (e.g., computer code), including C, C++, Java™ Ruby, Visual Basic™, and/or other object-oriented, procedural, or other programming language and development tools. Examples of computer code include but are not limited to, micro-code or micro-instructions, machine instructions, such as those produced by a compiler, code used to produce a web service, and files containing higher-level instructions that are executed by a computer using an interpreter. For example, embodiments can be implemented using Python, Java, JavaScript, C++, and/or other programming languages and software development tools. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different from illustrated ones, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features apply to one aspect of the innovations and are inapplicable to others.

Where a range of values is provided, it is understood that each intervening value, to the tenth of the unit of the lower limit unless the context dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms indicated to the contrary, such as “only one of” or “exactly one of,” or when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and the embodiments, the phrase “at least one,” about a list of one or more elements, should be understood to mean at least one element selected from any one or more of the elements in the list of elements, but not necessarily including at least one of every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as outlined in the United States Patent Office Manual of Patent Examining Procedures, Section 2111.03.

What is claimed is:

1. A method for optimizing and directing electronic communication using transformer-based neural networks, the method comprising:
generating, by one or more processors, from a set of electronic data sources, a training dataset comprising user profile data, time-stamped behavioral records captured across a plurality of electronic communication channels, external contextual events, and outcome indicators associated with clinical results;
training, by one or more processors, a transformer-based neural network with the training dataset by:
pre-training the transformer-based neural network to learn temporal relationships among events and actions, and
fine-tuning the pre-trained transformer-based neural network so as to reduce divergence between predicted outcomes and the outcome indicators by optimizing a dual-loss function that (i) applies a generative reconstruction loss causing the transformer-based neural network to predict masked events, and (ii) applies a discriminative outcome loss causing the transformer-based neural network to predict the recorded outcome indicators;
executing, by the one or more processors, the trained transformer-based neural network using a current user profile data, recent behavioral signals, and contemporaneous external events; and
outputting, by the one or more processors, an electronic communication instruction associated with the current user profile generated via the trained transformer-based neural network.

2. The method of claim 1, further comprising:
retrieving, by the one or more processors, the pretrained network.

3. The method of claim 1, further comprising:
combining the generative reconstruction loss and the discriminative outcome loss as a weighted sum whose gradients are jointly back-propagated through shared network parameters.

4. The method of claim 1, wherein the transformer-based neural network is an enhanced Bidirectional Encoder Representations from Transformers.

5. The method of claim 1, wherein the transformer-based neural network is trained to increase a total value (Trx).

6. The method of claim 1, further comprising:
automatically executing, by the one or more processors, the electronic communication instruction.

7. The method of claim 6, wherein the electronic communication instruction is causing an electronic communication session to be established between a device of a user and a secondary device.

8. The method of claim 7, wherein the electronic communication instruction is causing an electronic communication session to be established between a device of a user and a secondary device.

9. A system for optimizing and directing electronic communication using transformer-based neural networks, the system comprising a computer-readable medium having a set of non-transitory instructions that when executed by one or more processors, cause the oner or more processors to:
generate from a set of electronic data sources, a training dataset comprising user profile data, time-stamped behavioral records captured across a plurality of electronic communication channels, external contextual events, and outcome indicators associated with clinical results;
train a transformer-based neural network with the training dataset by:
pre-training the transformer-based neural network to learn temporal relationships among events and actions, and
fine-tuning the pre-trained transformer-based neural network so as to reduce divergence between predicted outcomes and the outcome indicators by optimizing a dual-loss function that (i) applies a generative reconstruction loss causing the transformer-based neural network to predict masked events, and (ii) applies a discriminative outcome loss causing the transformer-based neural network to predict the recorded outcome indicators;
execute the trained transformer-based neural network using a current user profile data, recent behavioral signals, and contemporaneous external events; and
output an electronic communication instruction associated with the current user profile generated via the trained transformer-based neural network.

10. The system of claim 9, wherein the instruction further cause the one or more processors to retrieve the pre-training the transformer-based neural network.

11. The system of claim 9, wherein the instruction further cause the one or more processors to combine the generative reconstruction loss and the discriminative outcome loss as a weighted sum whose gradients are jointly back-propagated through shared network parameters.

12. The system of claim 9, wherein the transformer-based neural network is an enhanced Bidirectional Encoder Representations from Transformers.

13. The system of claim 9, wherein the transformer-based neural network is trained to increase a total value (Trx).

14. The system of claim 9, wherein the instruction further cause the one or more processors to automatically execute the electronic communication instruction.

15. The system of claim 14, wherein the electronic communication instruction is causing an electronic communication session to be established between a device of a user and a secondary device.

16. The system of claim 15, wherein the electronic communication instruction is causing an electronic communication session to be established between a device of a user and a secondary device.

17. A system for optimizing and directing electronic communication using transformer-based neural networks, the system comprising one or more processors configured to:
generate from a set of electronic data sources, a training dataset comprising user profile data, time-stamped behavioral records captured across a plurality of electronic communication channels, external contextual events, and outcome indicators associated with clinical results;
train a transformer-based neural network with the training dataset by:
pre-training the transformer-based neural network to learn temporal relationships among events and actions, and
fine-tuning the pre-trained transformer-based neural network so as to reduce divergence between predicted outcomes and the outcome indicators by optimizing a dual-loss function that (i) applies a generative reconstruction loss causing the transformer-based neural network to predict masked events, and (ii) applies a discriminative outcome loss causing the transformer-based neural network to predict the recorded outcome indicators;
execute the trained transformer-based neural network using a current user profile data, recent behavioral signals, and contemporaneous external events; and
output an electronic communication instruction associated with the current user profile generated via the trained transformer-based neural network.

18. The system of claim 17, wherein the one or more processors are further configured to retrieve the pretrained network instead of pre-training the network.

19. The system of claim 17, wherein the one or more processors are further configured to combine the generative reconstruction loss and the discriminative outcome loss as a weighted sum whose gradients are jointly back-propagated through shared network parameters.

20. The system of claim 17, wherein the transformer-based neural network is an enhanced Bidirectional Encoder Representations from Transformers.
